(19) United States
(12) Patent Application Publication
(10) Pub. No.: US 2011/0151083 A1
(43) Pub. Date: Jun. 23, 2011

(54) CARTRIDGES FOR STORING FOOD MATERIALS AND METHODS AND APPARATUS FOR PROCESSING FOOD MATERIALS STORED WITHIN SUCH CARTRIDGES

(76) Inventors: Alan Soucy, Georgetown, MA (US); Kevin J. Hoyt, Sandown, NH (US); Richard DeSalvo, Danvers, MA (US); Jon Appleby, Acton, MA (US); Andrew Murphy, St. John's (CA); Ernest M. Santin, Wenham, MA (US)

(21) Appl. No.: 12/969,091

(22) Filed: Dec. 15, 2010

Related U.S. Application Data
(63) Continuation-in-part of application No. 12/454,969, filed on May 26, 2009.
Application No. 12/454,969 is a continuation-in-part of application No. 11/407,386, filed on Apr. 19, 2006.
(60) Provisional application No. 60/672,902, filed on Apr. 19, 2005.
(60) Provisional application No. 61/302,041, filed on Feb. 5, 2010.

(51) Int. Cl. A23L 1/48; B65D 85/00

(52) U.S. Cl. 426/412; 206/524.1

(57) ABSTRACT

The present invention relates in general to cartridges for storage and processing of pre-formulated food materials, and methods and apparatus for processing the food materials stored within such cartridges. More particularly, the present invention relates to a unique, fully recyclable food cartridge, comprising an annular cylindrical container within which the pre-formulated food material is sealed for storage and cooking, an integral burst disk, a discharge die located above the burst disk and a sensory device with information for controlling the thermo-mechanical processing of the food materials stored within such food storage cartridge by the method and apparatus. The method includes the steps of inserting the cartridge into the apparatus, causing the apparatus to heat and pressurize the annular container until the burst disk ruptures and collapsing the cartridge into a thin, recyclable disk by means of application of controlled pressure on the lower annulus of the container to assist in the ejection of the cooked food through the discharge die.

### CROSS-REFERENCE TO RELATED APPLICATIONS

This application is a continuation-in-part of U.S. patent application Ser. No. 12/454,969, filed on May 26, 2009 and of U.S. patent application Ser. No. 11/407,386, filed on Apr. 19, 2006 (which claimed the benefit of U.S. Provisional Patent Application No. 60/672,902, filed on Apr. 19, 2005).

This application claims priority to and the benefit of U.S. Provisional Patent Application No. 61/302,041, filed on Feb. 5, 2010.

The entire disclosures of all of related applications are hereby incorporated herein by reference.

### FIELD OF THE INVENTION

The present invention relates generally to methods for processing expandable food materials and, in particular, to a cartridge for storing and processing of food materials and a method and an apparatus for use in processing of the food materials within the cartridge.

### BACKGROUND OF THE INVENTION

Fast food is a staple of American life that has taken various forms, including: (i) ready-to-eat cold snacks, such as granola bars, meat and cheese sticks and protein drinks; (ii) partially prepared ingredients, such as instant coffee, oatmeal and cake and other mixes, which need to be combined with additional ingredients, e.g., eggs, milk and water, before preparation; and (iii) fully prepared foods, such as canned soups, premixed cookie dough, frozen foods and TV dinners, which require only heating.

Fast food is in a constant state of evolution. New materials allow food to be heated and served in its display package so waste is reduced. New sterilization methods allow almost unlimited shelf life without refrigeration. Microwave cooking shortens preparation time to seconds instead of minutes.

As will be appreciated by the average consumer, however, “fast” food does not necessarily mean “good” food.

As a result, there is a drive to create gourmet quality fast foods. As but one example, companies have developed ground coffee and an integral filter all stored in a flavor and aroma preserving individual container which, when combined with a dispensing appliance, brews a fresh cup of coffee on demand with none of the usual “instant” coffee shortcomings.

The “bread machine” is the food industry's existing answer to a gourmet quality “cooked-on-demand” grain-based food product. However, the procedure involved with such machinery is time-consuming and there is significant cleanup required.

Today's fast paced lifestyle demands a food processing device having the same characteristics now associated with the premium coffee brewing machines.

Mass-produced breakfast cereals, some of which use expandable food materials, have several disadvantages, for example, high cost, the inclusion of preservatives and other unwanted ingredients, and a lack of choice of ingredients. A consumer with allergies, for example, is limited to certain selections and types of products. Similar disadvantages exist for other mass-produced food products, such as, for example, snack foods, croutons, bread crumbs, and other types of puffed foods.

Health conscious consumers depend on major commercial food manufacturers to provide freshness and balanced nutrition in their breakfast cereals. Unfortunately, due to the high-shear processes used in producing these cereals and the addition of preservatives for the purpose of increasing shelf life, the health, freshness and nutrition aspects of the food suffer greatly.

This invention provides a method for conveniently producing freshly made highly nutritious, breakfast cereals to the health conscious home consumer by means of a low-shear extrusion process.

This invention will further provide a method for conveniently producing freshly made and highly nutritious snack and pet foods, also in the home environment.

In the pet food application, the invention provides an improved nutritional value over commercially sold pet food, avoidance of uncontrollable portions experienced with bulk quantity food, and elimination of the need for large bag purchase and storage.

Additional applications of the invention can include, but are not limited to, pasta extrusion and crouton extrusion.

Apparatus for processing expandable food materials typically utilize screw-type extruders that can impart excess shear on the food material, thereby degrading the food material and the finished product. Some of the methods and apparatus used for processing food materials can negatively impact the taste and texture of the finished product. For example, shear can degrade starch molecules forming dextrin, an undesirable by-product, and degrading product quality. Additionally, shear is also responsible for substantial wear of screws and barrels, thereby shortening the life of the equipment.

In prior art devices, food ingredients are continuously fed into a process chamber which often incorporates a continuously spinning auger, upwards of 100 feet long. The auger mixes the ingredients, generates heat and pressure within the chamber and advances the mixed food material towards the discharge nozzle at the end of the chamber. Differential between the interior chamber pressure and the exterior chamber pressure (atmospheric) causes the mixed/heated food material to discharge through the nozzle. As the food material exits the nozzle, it expands and is cut to desired lengths by means of rotating blades. Expansion occurs as a result of flashing (instant boiling) of most of the water content within the food material upon exposure to atmospheric pressure outside of the process chamber. Expansion rate is controlled by regulating the moisture and starch percentages of the food material prior to exit through the nozzle. After the discharged food material is cut, it is transported to a baking chamber where it is dried to a moisture content of approximately 8 percent. The drying process in combination with added chemical preservatives prevents bacterial growth, thereby, increasing shelf life of the final food product.

The heat required for the prior art processes is generated as a result of friction developed between the auger and the food material. In addition, some of the food material is ground between the auger and chamber wall. These actions cause high shear within the food material, thereby destroying a large percentage of its nutrient and starch contents.

Chemical preservatives are added to the food product, making that product capable of being stored in warehouses and on store shelves for prolonged periods of time. Given the choice, today's health conscious consumers prefer food products that are freshly made and free of chemical preservatives.

Also prior art pet food products are either supplied in pre-cooked condition, whether in bulk or individually packaged portions, or in raw food condition, only available through niche markets and at a more expensive price point. Consumers have thus sometimes been compelled to substitute human food for their pets to achieve the desired nutritional value and freshness.

The elements disclosed by the instant patent application and for which patent protection is being sought, that are neither disclosed by nor rendered obvious in view of prior art, are unique cartridges or pods for a home kitchen appliance designed and sized for use on a kitchen counter or in a pet feeding area, for conveniently producing single and/or multiple servings of nutritious, freshly made food products. The cartridges or pods are used in an appliance that performs the processes of mixing, baking and extruding grain based ingredients in a form that provides a nutritionally sound food, in individual serving sized portions.

The food ingredients used for producing food products in accordance with the present invention are purchased separately as a pre-formulated and pre-mixed batch that is sealed inside a cartridge or pod constructed with an integrated extrusion nozzle. In the pet food application, the cartridges or pods are formulated and sized according to specific daily nutrition requirements of end use animals, which is beneficial to portion control and weight management.

The appliance utilized with the unique cartridges or pods is designed to perform the process of food preparation in a few minutes, utilizing a combination of pre-mixed ingredients in the cartridge or pod with no preservatives or artificial ingredients. The process permits a “no muss, no fuss” production and clean up.

Other novel features that are disclosed include:

1. longer useful life of the apparatus;

2. reduced degrading of food material;

3. less degradation of starch molecules and formation of undesirable dextrin by-product;

4. on demand manufacture of ready to eat (RTE) breakfast cereal;

5. tailored selection of finished product taste and texture;

6. individual choice of and flexibility regarding ingredients;

7. avoidance of the inclusion of preservatives and other unwanted ingredients;

8. ingredient content control to address allergy issues;

9. economical cost per batch of the finished product; and

10. elimination of “overhead costs” of commercial cereal manufacturers.

### SUMMARY OF THE INVENTION

An integral part of the food preparation device is the container in which the ingredients reside. The container, hereafter called the food “cartridge” or “pod,” has multiple functions. It serves as a sealed, recyclable, variable-serving-sized, sterilized package in which the product ingredients and precise amount of moisture are stored. In conjunction with the associated appliance, the cartridge or pod is the pressurized cooking vessel. It has an annular design in order to provide maximum surface area contact with the food contents to insure even heat transfer during cooking. It provides cooking directions to the associated appliance via barcode, magnetic stripe, or other means. It incorporates a burst disk designed to rupture when the heated food material reaches a specific extrusion pressure. It includes a discharge (extrusion) die nozzle for controlling the expansion rate, cross-sectional shape, and finished texture of the food product. It is designed to crush evenly as external pressure is applied to insure complete ejection of the cooked food contents. And, finally, it isolates the appliance from the food thereby simplifying or eliminating cleanup after cooking

The invention generally relates to a low shear food cooker/extruder for the customized production of breakfast foods (such as cereals) and similar food products. In one embodiment, the invention relates to a counter-top breakfast cereal apparatus targeted for the consumer (home use) market. The cooker/extruder can be used to freshly produce ready to eat (RTE) breakfast cereal for the consumer. The cereal would be made on demand and, if preferred, preservative-free, with ingredients tailored to particular taste and texture preferences. Some of the advantages of a apparatus and related processes in accordance with the invention are that batches are made fresh and on demand; preservatives are not required in the recipes; cost per batch is economical, whereas, overhead costs passed on by commercial cereal manufacturers are eliminated; consumers with allergies to specific food materials control ingredient content of their recipes; and better overall output quality due to minimized starch damage within the final food product.

In another embodiment, the invention relates to a compact pet food production apparatus targeted for the consumer (home use) market that can be placed in the customary pet food feeding area.

In one aspect, the invention relates to a very low shear cooker/extruder utilizing a piston to extrude the expandable food material. In one embodiment, the piston can include a rotating mechanism to introduce a minimum amount of shear as may be necessary to aid the cooking of the food product, but not enough to damage the food product. Additionally, the cooking can be performed under pressure as high as about 500 psi. A variety of dies or nozzles can be used with the extruder to produce different finished products and to accommodate different viscosity food products.

Generally, the cooker/extruder apparatus includes three basic modules: a compression module, a dryer module, and a control unit. The apparatus is capable of cooking, forming and puffing a food product, such as, for example, cereals, snack foods, breadsticks, croutons, pet foods, and textured vegetable proteins, without the use of oil, hot air or gun-puffing, for example, to puff the product. Additionally the apparatus could be used to produce non-puffed foods, such as pellets or other half-product made for later processing by other means, e.g., frying. The apparatus can vary in size and configuration to suit specific applications. For example, a relatively small manually operated unit could be produced as a home appliance. A larger version could be manufactured for in-store production, such as might be found in supermarket bakeries or health-food stores. A larger and more sophisticated automated machine may also be produced.

In one embodiment, the compression module includes a chamber for inserting and processing raw food materials, a quick-release sealed chamber cover for maintaining high pressure during the cooking/extrusion process, a heating element that surrounds the chamber, a variable speed piston for ejecting processed food materials from the chamber, a piston drive mechanism, and an adjustable pressure-activated nozzle for controlling the expansion rate of food materials ejected from the chamber. The piston drive mechanism could be mechanically (e.g., a screw), electrically, hydraulically, or pneumatically driven.

The dryer module, in one embodiment, includes a variable speed blade for cutting extruded/expanded food material to desired lengths, a bin for capturing and containing said food material, a heater for drying and toasting said food material, a blower for circulating said food material during the drying/toasting process, and an enclosure that houses the blade, bin, heater and blower.

In one embodiment, the control unit includes electro/mechanical hardware and circuitry, which controls all electrical, mechanical, and physical aspects of the cooking, extrusion, drying and toasting processes. All of the necessary hardware and circuitry is housed inside a grounded enclosure.

In another aspect, the invention relates to methods of producing food products with low or very low shear. The methods involve thermo-mechanically processing the food products. The methods include introducing a raw or partially processed food product into a compression module, heating and/or pressurizing the food product to cook the product, and extruding the product under minimal shear.

In another aspect, the invention relates to a food product as produced by a method in accordance with one embodiment of the invention, such as, for example, cereal or a puffed cheese snack. The methods and apparatus of the invention can be carried out with a variety of raw ingredients to suit a particular user's tastes. For example, pre-stressed or pre-gelatinized ingredients could be used, such as melted starches. The apparatus can include additional modules for modifying the extruded food product, for example for flavoring or combining with other food products.

In yet another aspect of the invention, each batch of ingredients is sealed in a cartridge or pod that has a moisture percentage that is adequate to produce the desired product and yet low enough to prevent bacterial growth and rancidity during storage. If the finished food product requires fat, e.g., for nutritional value, or if it requires flavorings or seasonings, these can be stored in a reservoir in the pod or outside the pod. The cartridge or pod is placed in the compression module of the apparatus for processing.

In yet another aspect of the invention, individual cartridges or pods can have an attached bar code that contains processing parameters unique to the intended finished food product in the particular cartridge or pod and which bar code is read by the appliance's control system at the beginning of the process in order to convey the requisite processing parameters to the compression module and drying module of the appliance.

In yet another aspect of the invention, the cartridge or pod contains premixed dry ingredients and water is introduced into the premixed dry ingredients, either from a water blister within the cartridge or pod that is mechanically burst or pierced, or from a water reservoir outside of the pod.

In yet another aspect of the invention, the dry ingredients and water are mixed within the cartridge or pod by a combination of timed vibration at controlled frequencies and mechanical manipulation, or by heating the water and resultant steam migration.

In yet another aspect of the invention, the cartridge or pod is pressurized while the food mixture is heated, and then the pressure is increased and the cartridge or pod burst disk bursts and the food material is extruded out the discharge die, causing the food material to expand as a result of flashing (instant boiling) of most of the water content within the food material upon exposure to atmospheric pressure outside of the discharge die, before it is cut into desired sizes.

In yet another aspect of the invention, as the food ingredients within the cartridge or pod are processed by the appliance and the food material is extruded the pod is collapsed, such that the cartridge can simply be removed from the appliance for recycling.

The invention is unique in that:

a. The invention has its process parameters (pressure and temperature) being applied to the food material as opposed to being produced by the food material, making the process highly efficient in ingredient consumption (cost), nutrient provision, control and repeatability.

b. The food produced by this invention requires no preservatives. It is made fast, fresh, on demand and ready to eat.

c. The heat required for this process is generated external to, and is conducted into, the food material. Nutrient levels are maintained because the food material remains static throughout the heating phase, generating zero friction and zero shear.

d. Food material is subjected to low shear only as it passes through specially engineered geometry within the discharge die. This low shear assists in expanding the food material, while causing minimal to zero damage to its nutrients and starch content. Dogs and cats prefer foods having undamaged starch and, quite often, will refuse to eat foods having damaged starch.

e. Because the food produced by this invention is “ready to eat” and requires no final packaging:
i. If demand dictates, specific pods could be formulated with natural preservatives to allow for delayed consumption of the finished food product while maintaining its nutritional value.
ii. The food does not require post-process drying. Furthermore, since moist foods are highly palatable to dogs and cats, pet food pods could be formulated for high post-extrusion moisture content.

f. With the exception of the cutting blades, the appliance does not require cleaning between pod insertions. Food materials make contact with the pod and its integrated nozzle and the cutting blades only. The pod with its integrated nozzle is recyclable. Alternative embodiments integrate the cutters into the pod nozzle, making cleaning of the appliance optional but unnecessary.

g. Pods can be continuously processed for fast production of multiple servings of multiple food types. The user only needs to remove the latest spent pod, insert an unprocessed pod and press start. These and other objects, along with advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic side view of a compression module for an apparatus for processing expandable food materials, in accordance with one embodiment of the invention;

FIG. 2A is a schematic perspective view of the compression module of FIG. 1;

FIG. 2B is a second schematic perspective view of the compression module of FIG. 1;

FIG. 2C is a third schematic perspective view of the compression module of FIG. 1;

FIG. 2D is a fourth schematic perspective view of the compression module of FIG. 1;

FIG. 3 is an exploded schematic perspective view of the compression module of FIG. 1;

FIG. 4A is a schematic perspective view of a dryer module for an apparatus for processing expandable food materials, in accordance with one embodiment of the invention;

FIG. 4B is a second schematic perspective view of the dryer module of FIG. 4A;

FIGS. 5A-5I are schematic perspective views of the dryer module of FIG. 4A, in various stages of construction;

FIG. 6 is a schematic view of a control unit for an apparatus for processing expandable food materials, in accordance with one embodiment of the invention;

FIG. 7 is a schematic view of three positions descriptions for the toggle switch of FIG. 6;

FIGS. 8A and 8B are a perspective view from the top and bottom of a disposable food cartridge in accordance with one embodiment of the present invention;

FIG. 9 is an exploded perspective view of the basic components of the food cartridge shown in FIGS. 8A and 8B;

FIG. 10 is a side elevational view of the food cartridge shown in FIGS. 8A and 8B showing the piston;

FIG. 11 is a vertical section of FIG. 10 taken at line 11-11;

FIGS. 11A and 11B are detailed views showing alternative ways in which the side wall and the edge of the planar circular lid of the food cartridge of FIG. 11 may be crimped together to form a seal;

FIG. 12 is a vertical section of FIG. 10 taken at line 12-12;

FIG. 13 is a horizontal section of FIG. 10 taken at line 13-13;

FIG. 14 is a vertical section of FIG. 10;

FIG. 15 shows several potential cross sectional views of the opening of the extrusion nozzle 11 of FIG. 10 taken at line 15-15;

FIG. 16A is a horizontal view of a crushed food cartridge;

FIG. 16B is a cross sectional view of a food container loaded in the apparatus before commencement of the cooking process.

FIG. 17A is a horizontal view of an alternate embodiment of the piston of FIG. 10;

FIG. 17B is a vertical section of the piston of FIG. 17A taken at line A-A;

FIG. 18 shows an exploded perspective view of a second embodiment of the food cartridge with no center boss;

FIG. 19 shows an additional embodiment of the food cartridge with an alternate location for the nozzle;

FIG. 20 shows an additional embodiment of the bottom of the food cartridge with a break-away bottom lid;

FIG. 21 shows an additional embodiment of the food cartridge with an internal piston;

FIG. 22 is a graph illustrating net power over a range of time according to some embodiments;

FIG. 23 is a graph illustrating time over a range of pressures according to some embodiments;

FIG. 24 is a graph illustrating temperatures over a range of time according to some embodiments; and

FIG. 25 is a graph illustrating UTC over a range of time according to some embodiments.

### DETAILED DESCRIPTION OF PREFERRED EMBODIMENT

Embodiments of the present invention are described below. It is, however, expressly noted that the present invention is not limited to these embodiments, but rather the intention is that all equivalents and all modifications that are apparent to a person skilled in the art are also included. In particular, the present invention is not intended to be limited to any specific food material or end product, or (unless expressly stated otherwise) to any specific pod shape or pod material.

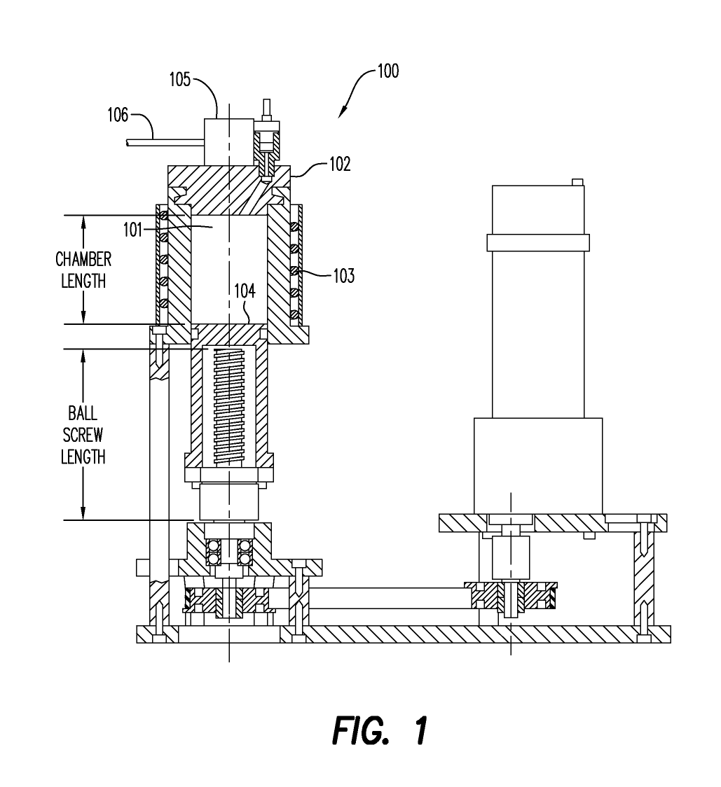

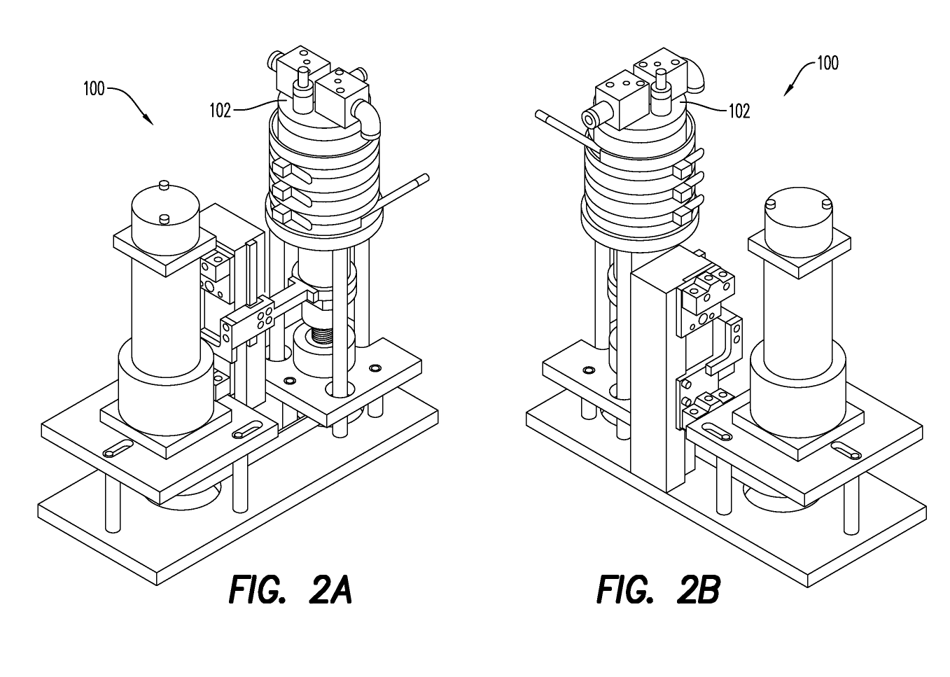

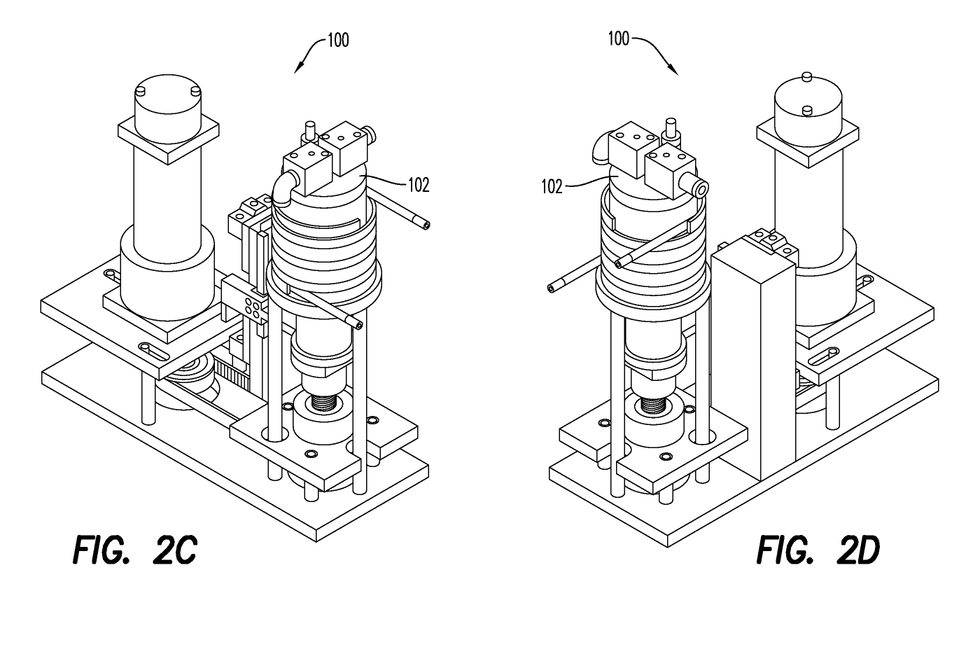

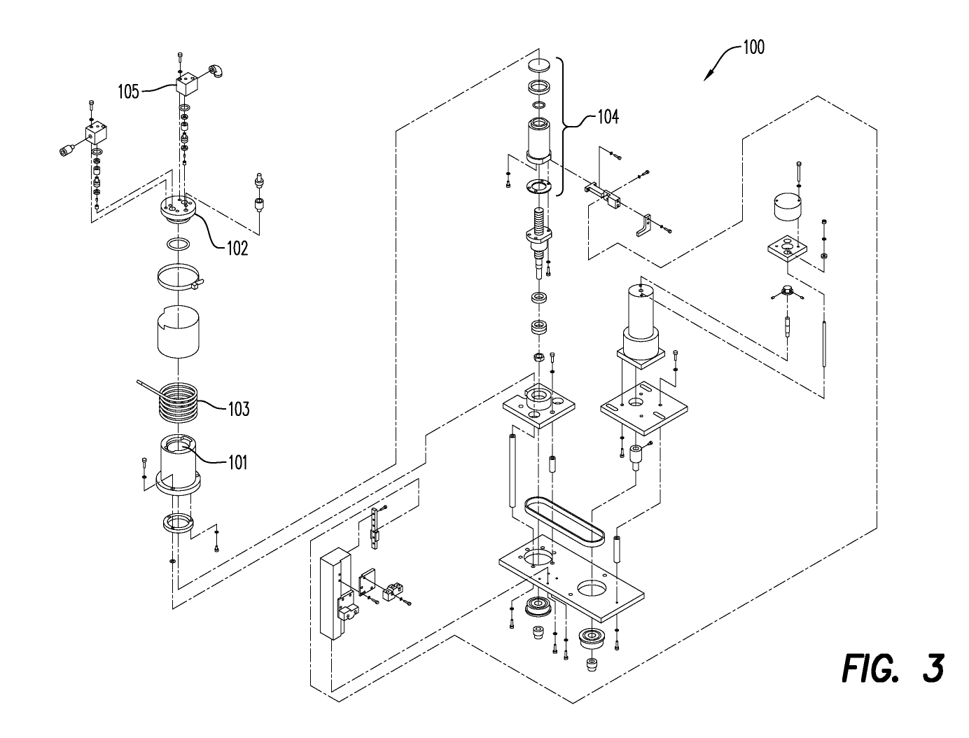

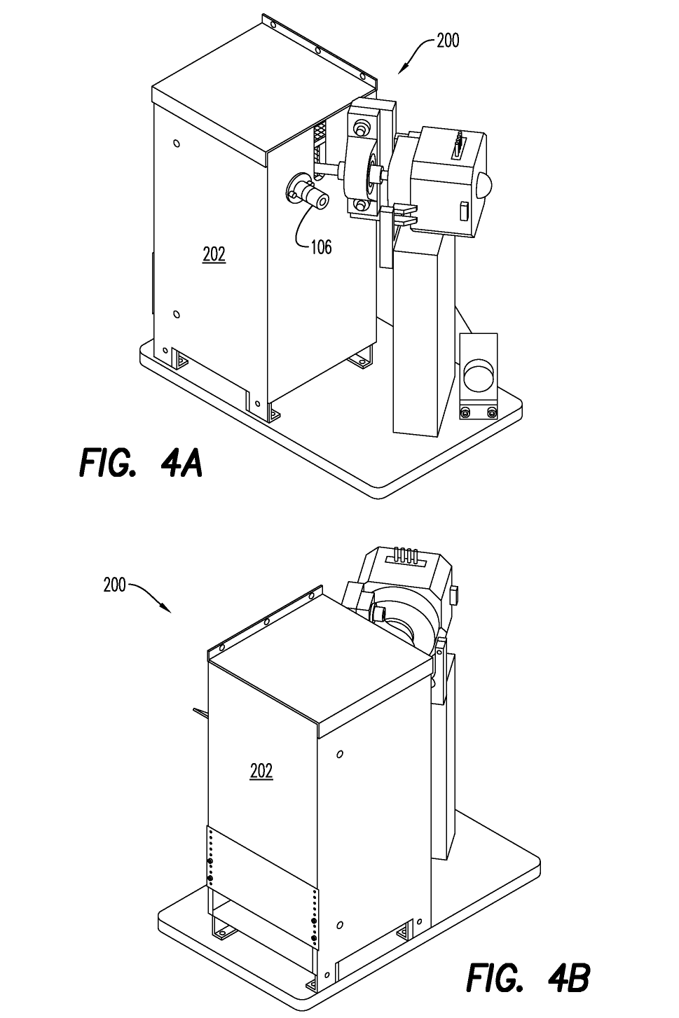

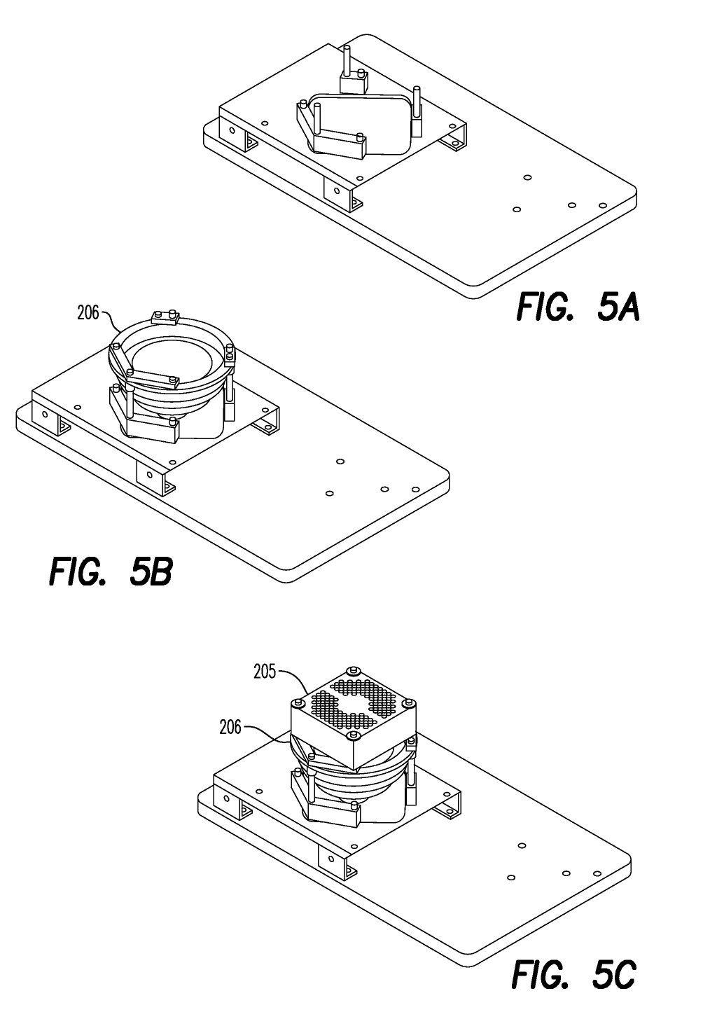

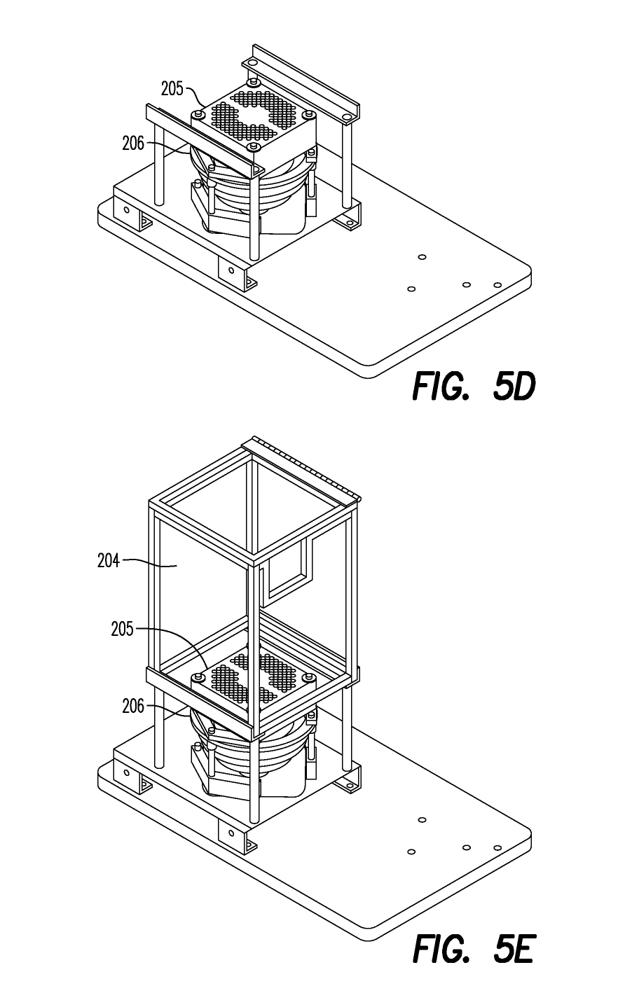

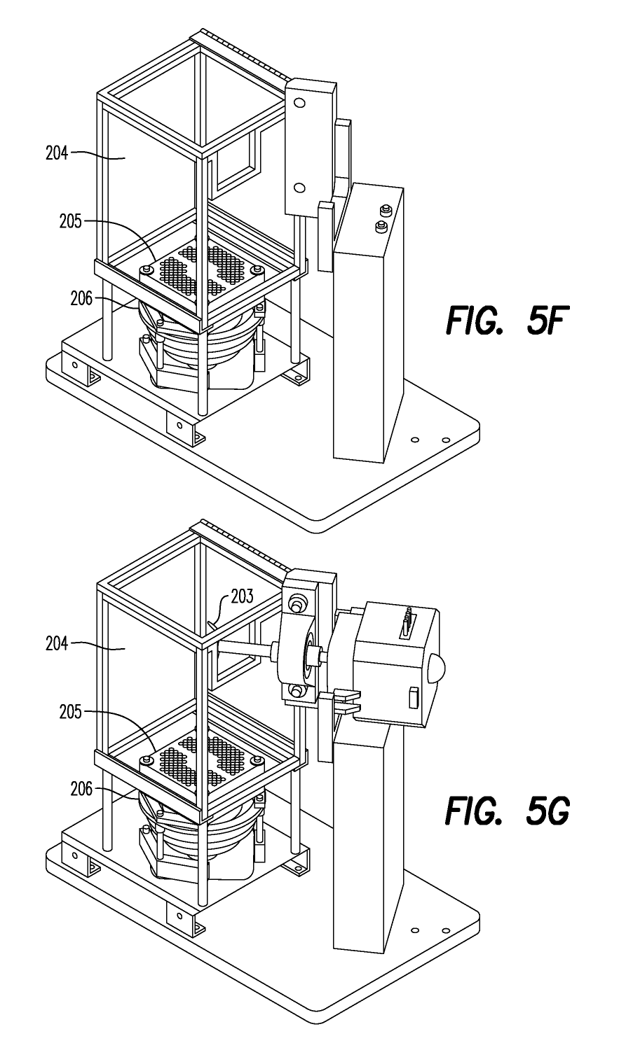

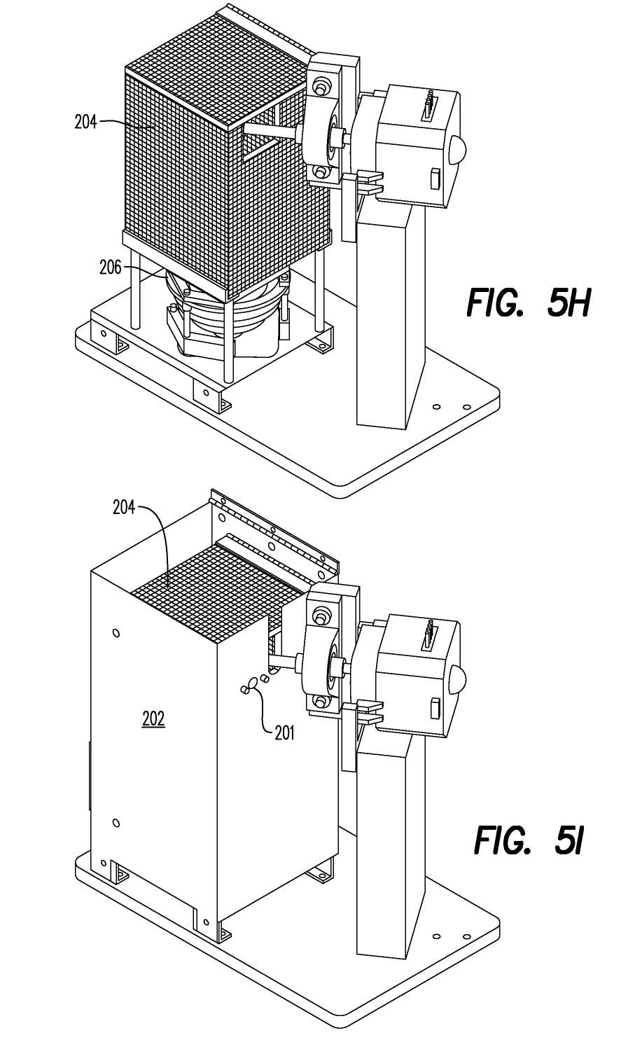

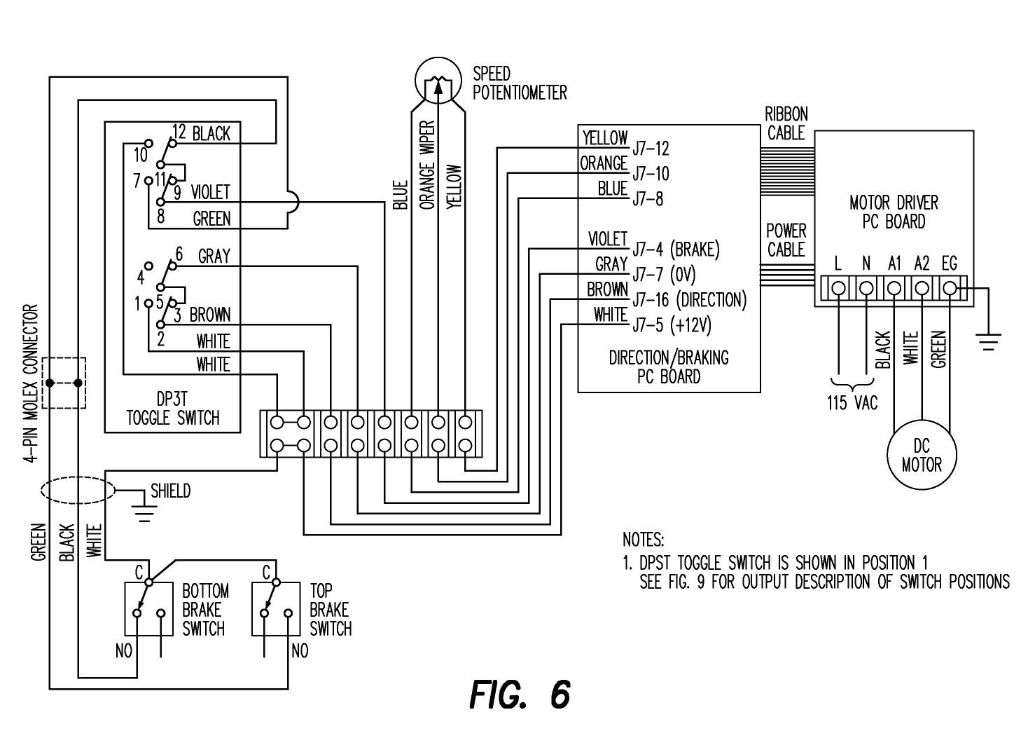

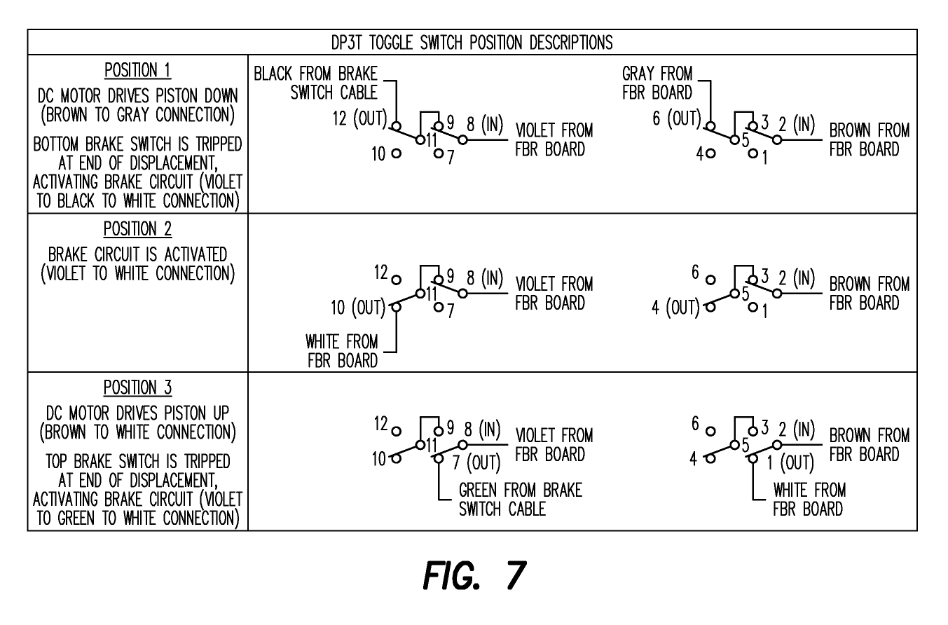

The compression module includes the components listed and arranged as shown in FIGS. 1 through 3. FIGS. 6 and 7 show an electrical schematic representing one embodiment of a control unit for operating the apparatus. The dryer module includes the components listed and arranged as shown in FIGS. 4A through 5I. The operation of the various modules and components are described herein below.

The invention also relates to a variety of methods of producing food products. Generally, the operation of the apparatus includes the following steps. Food materials of a particular recipe are inserted into the chamber 101 of the compression module 100 and the chamber cover 102 is attached and sealed to the chamber and locked. The heating element 103 is activated to begin the cooking process. As the closed-volume cooking process proceeds, the pressure and boiling point of the food materials continuously elevates above their atmospheric levels, and the starches within the food material transform to a plasticized state. After a specified elapsed cooking time (dependant on recipe and ingredient quantities, for example), the heating element is deactivated to terminate the cooking process. The piston 104 is then activated to begin the extrusion process by decreasing the volume of the chamber and, thereby, further increasing the differential pressure between the food materials within the chamber and atmospheric pressure outside of the chamber.

Once the pressure of the food materials within the chamber reaches a pre-determined level, the nozzle or valve 105 opens, allowing the pressurized food material to flow from the chamber out the discharge tube 106. The piston remains in motion until all food materials within the chamber have been ejected. Approximately ninety five percent of the water content within the food material instantaneously boils upon exit from the nozzle, causing the ejected food material to expand. Expansion rate is dependent upon original water content of the recipe and is controlled by multiple mechanical parameters, such as nozzle orifice size and piston speed. At ejection, the plasticized starches throughout the food material go through a glass transition, that is, they form cellular structures that cool rapidly to maintain the size, shape and texture of the expanded food product.

The expanded food product flowing from the compression module nozzle 105 out the discharge tube 106 optionally enters the dryer module 200 through an opening 201 in the enclosure wall 202 thereof. After exiting from this opening, the food product is cut into equal length sections by a spinning blade 203. Section length is selected based on the desired size and/or shape of the finished food product. Section length is determined by the speed of the blade 203. Depending on the type of food product produced, the dryer module may not be needed as the product can be air dried and manually cut or otherwise manipulated. Additionally, other processes can be carried out to sweeten, flavor, color, texturize, enrich, and otherwise treat the finished food product.

After being cut, the food sections are gravity fed into a perforated holding bin 204. Once the complete batch of food product has been sectioned and is in the holding bin 204, a heater 205 and a blower unit 206 are both activated. In one embodiment, the heater 205 is located directly beneath the holding bin 204 and has an output of approximately 400 watts and is toggled on and off by a thermostat control. The heater's function is to toast the food product for added flavor and decrease its moisture content to, for example, between about three percent and about five percent. The desired resultant moisture content will depend on the food product being produced. In one embodiment, the blower unit 206 is located directly beneath the heater 205, has an output of approximately 20 cfm, and remains on throughout the drying/toasting process. The blower's function is to promote even heating and to prevent burning of the food product by circulating the food sections within the bin 204 during the drying/toasting process.

The size of the apparatus and the size and arrangement of the various components of the apparatus will be selected to suit a particular application. In one embodiment, a cylinder 101 having a diameter from about 0.25″ to about 4″ is used. The piston 104 stroke can be from about 0.5″ to about 18″. The apparatus can be scaled up or down to suit the particular application, for example as a home appliance or for an industrial application. For example, in the compression module 100, the cylinder 101 size and quantity will be selected based on the amount of product to be produced, the heat transfer requirements, and the desired cycle time. For example, better heat transfer permits the use of raw feeds and higher temperatures that will allow operation at reduced moistures for better product quality.

One of the considerations when selecting the size of the cylinder 101 is the time required to achieve a desired level of heat penetration, which is approximately proportional to the square of the cylinder's diameter. For example, if it takes one hour to heat a 2″ cylinder, we expect the same results in 15 minutes with a 1″ diameter cylinder. And, using the same piston 104 stroke, the production rate will remain constant. Each shot will have ¼ of the original quantity, but will happen four times more frequently. Moreover, multiple cylinders (like in a reciprocating engine) can be used to increase the product output. A description of thermal penetration can be found in Heldman and Singh, Food Process Engineering, pp. 124-130, the disclosure of which is hereby incorporated by reference in its entirety.

In another embodiment, an annular piston can be used. Although a more complex design, converting from a circular cross-section to an annular cross-section vastly increases the heat transfer area (heating inside and outside the annulus) with a dramatic decrease in cycle time and improvement in product uniformity. For example, replacing the solid 2″ piston with a hollow 3″ piston would require an inner diameter of 2.24″ for the same volume with the same stroke. But the heat transfer area would increase by a factor of about 2.6, and the relative distance that the heat would have to penetrate would be only about 38% of that in the 2″ piston. A one-hour heating cycle could be reduced to about 8.8 minutes with this design. With that reduced cycle time, the production rate would increase about 6 times.

In one embodiment, the cylinder head is insulated to, for example, minimize condensation at the cold spot in the center of the product and the loss of heat to the atmosphere. Additionally, the cylinder wall thickness can be varied to alter the heat transfer properties. The material of the cylinder can be, for example, stainless steel, an aluminum/stainless sandwich (as used in waterless cookware), or normal mild steel with a stainless liner.

The apparatus of the present invention is an improvement over the prior art at least because of its lack of shear until the product enters the final die orifice, which is an inherently high-shear operation required to create the desired product characteristics. Shear earlier in the process (for example in the screw of a standard extruder where it is responsible for generating most of the heat required to cook and puff the product) does little to build texture, and can be detrimental to product quality by damaging, or dextrinizing, the starch molecules. The present invention utilizes external methods of heating, such as conduction heating, thereby eliminating the damaging shear.

The size of the die should be selected to optimize discharge speed, but will also vary depending on the raw materials used and the food product to be produced. There is an optimum extrusion flow rate for any particular die size. For larger product size, requiring a larger die hole, the piston speed can be increased. The die orifice itself can be streamlined for better product formation.

Moisture is another operating parameter that affects the final food product produced. In one example, the mix used in the test was formulated to be at 25%, which is higher than normally used for expanded products. After mixing for about 1 hour, the moisture was measured by loss-of-weight in a microwave oven to be about 17%, which is about ideal for standard corn-based snack extrusion.

The following test data is included to be illustrative only.

I. Power Input and Shell Temperature:

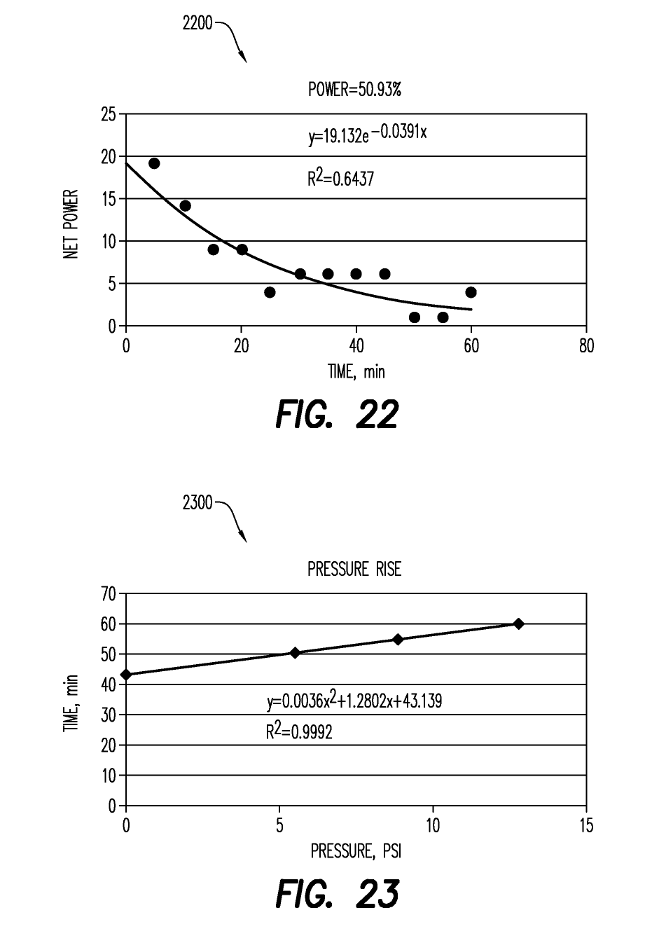

In one test, the power to the electrical heater was adjusted to maintain an average shell temperature of about 453 deg. F., starting with an initial power setting of about 100% and dropping as the sample heated up to avoid overheating the outer surface of the product within the cylinder. Applying an exponential model, a final power setting of about 51% is expected at equilibrium. Assuming that the potentiometer setting is proportional to the actual power delivered, about half of the total coil power at that temperature is lost to the atmosphere. FIG. 22 is a graph 2200 illustrating net power over a range of time according to some embodiments.

II. Heat Penetration—Pressure and Product Temperature:

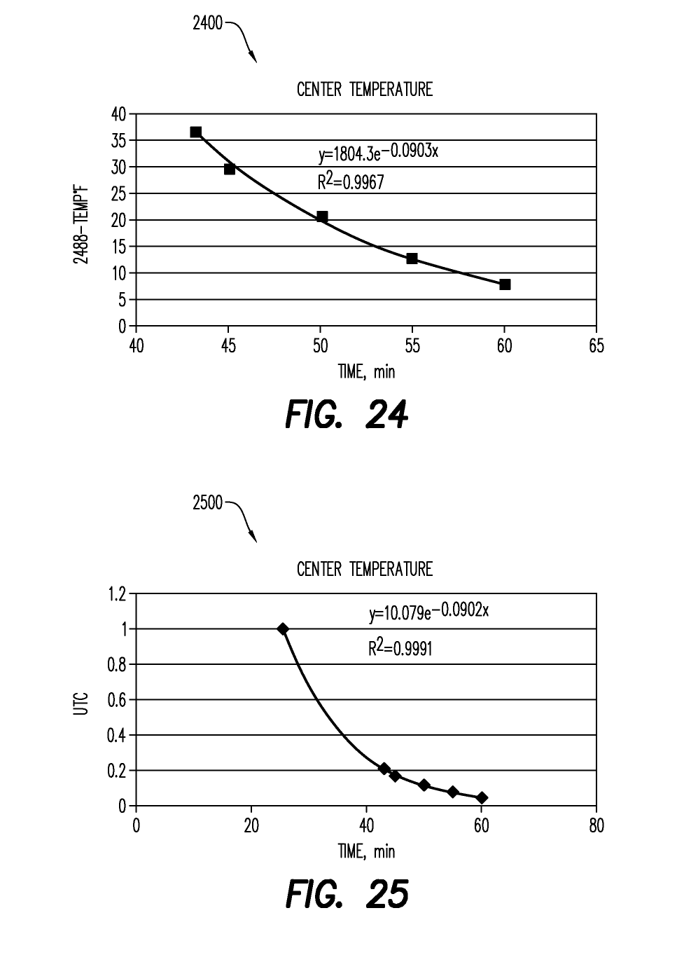

Moisture migrates from the outer portions of the cylinder to the center due to the temperature gradient. The center portion remains cool for a period of time required for the heat to diffuse inward, and then its temperature starts to rise, eventually coming to equilibrium with the outer portion. This picture is complicated somewhat by the head space above the product which allows the moisture to move quickly to those cooler portions, and the effect of the unheated cylinder head which prevents that top-center portion from coming to equilibrium. Some of the energy loss noted above would be through the head.
Center Temperature Estimation: It was assumed that the temperature at the top center was that which would be in equilibrium with the pressure measured in the head space (steam, created by the hot outer portion, would condense in the center at a temperature in equilibrium with the pressure).
Equilibrium Temperature: Using the exponential model, an equilibrium final temperature for the top center position was estimated at about 249 deg. F., considerably lower than the shell temperature, and much lower than the normal temperature range usually required for good expansion. An additional point on this curve was generated by extrapolating the pressure curve backward in time to zero pressure (one atmosphere absolute) where the temperature would be about 212 deg. F. This occurred at about 43 minutes. FIG. 23 is a graph 2300 illustrating time over a range of pressures according to some embodiments, and FIG. 24 is a graph 2400 illustrating temperatures over a range of time according to some embodiments.

Dimensionless Format Unsteady-state heat transfer data are usually converted into dimensionless form for analysis. Knowing the initial and final temperature, the conversion is:

$$UTC = \frac{{T}_{f} - T}{{T}_{f} - {T}_{i}}$$

where:
   Tᵢ=initial temperature
   T_{f}=final temperature
   UTC=unaccomplished temperature change
UTC goes from 1 to zero at infinite time.

FIG. 25 is a graph 2500 illustrating UTC over a range of time according to some embodiments. Penetration Time: The resulting curve fit the exponential model well, and was extrapolated back to UTC=1 for an initial temperature of about 70 deg. F. That occurred at about 25.6 minutes, which is about how long it took for the first heat to penetrate to the center of the cylinder.

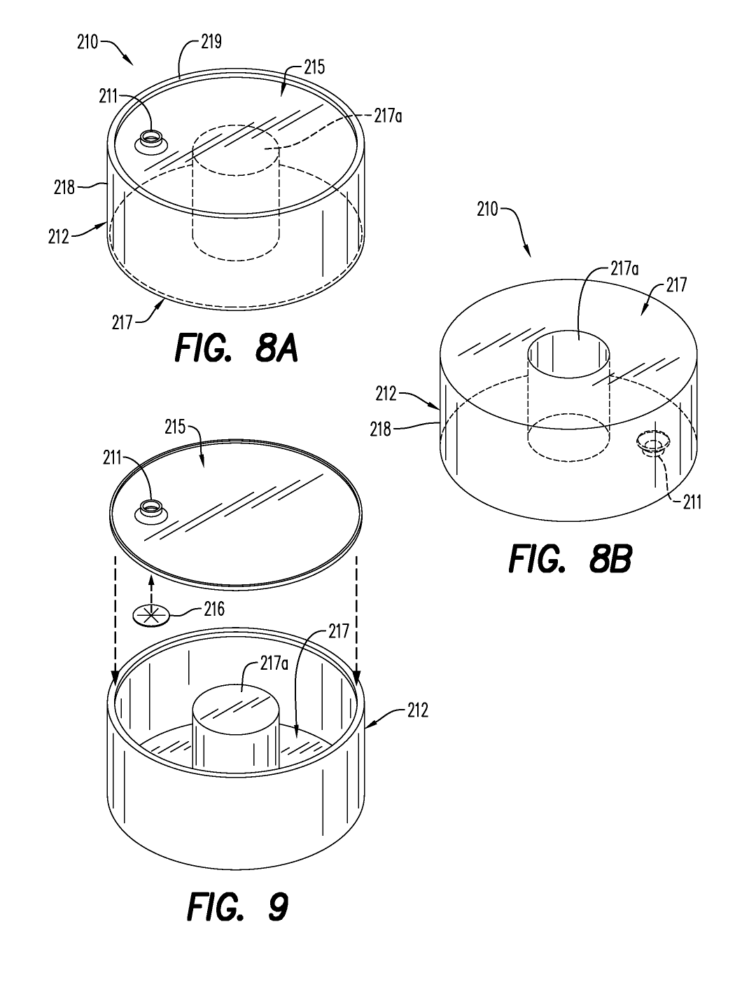

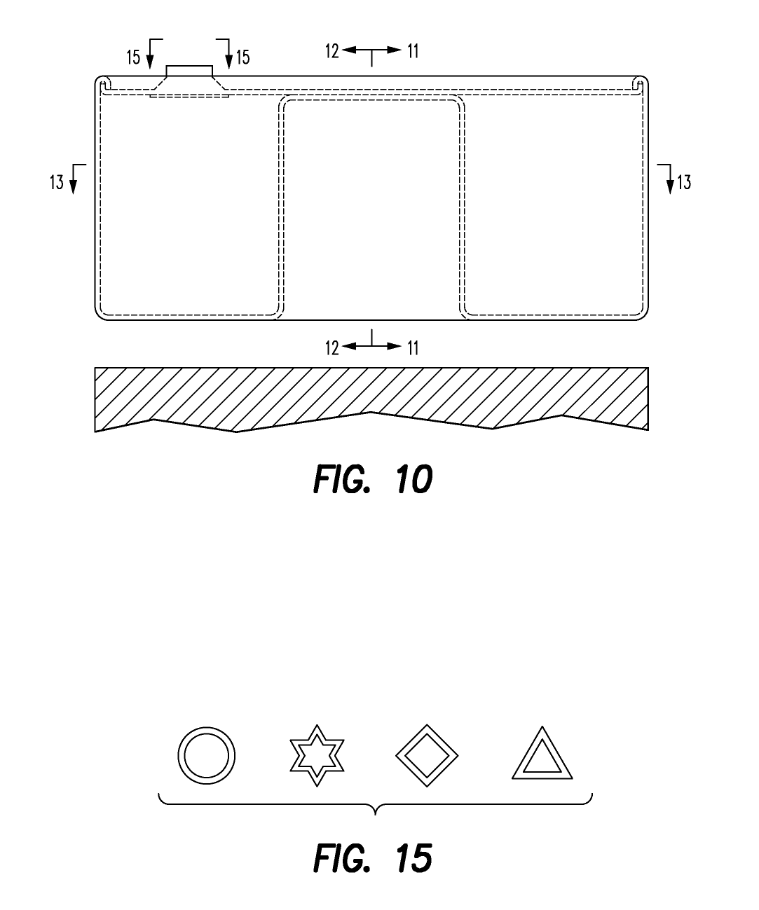

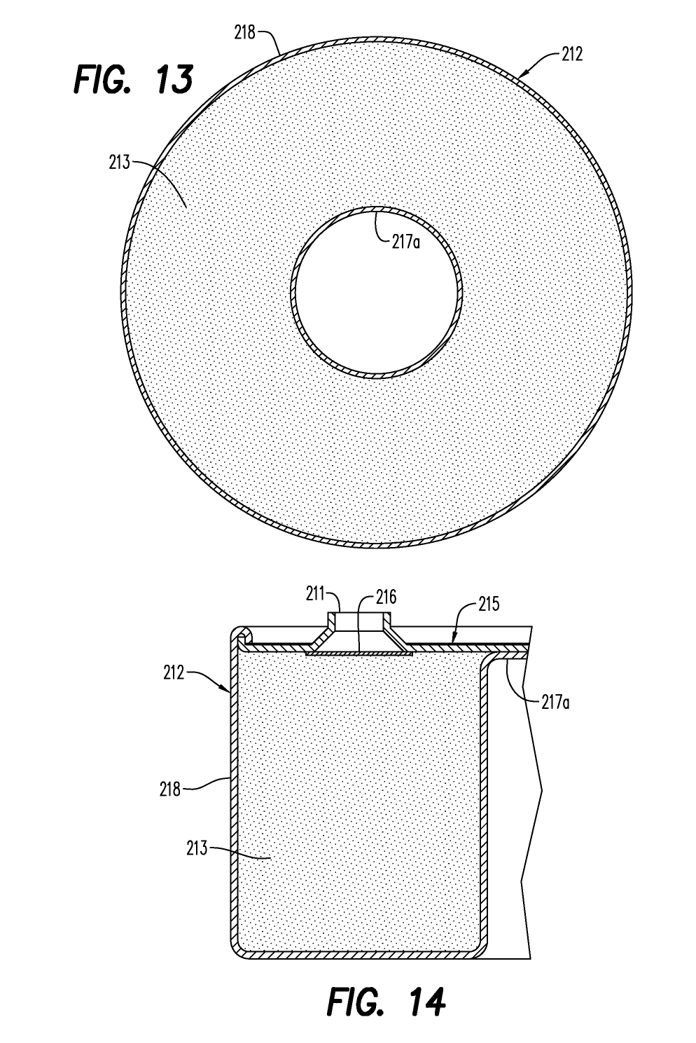

Various embodiments of cartridges or pods that fall within the scope of this invention are shown in FIGS. 8A through 21. These cartridges or pods can be utilized to store and deliver food materials of a particular recipe to the chamber 101 of the compression module 100 for processing as hereinabove described.

With reference to FIGS. 8A-15, a food cartridge in accordance with a first embodiment of the invention is generally depicted at 210. As shown in FIG. 9, the basic components of the food cartridge include an annular cup-shaped container 212, a burst disk 216, and a planar circular lid 215 with integral extrusion die nozzle 211.

The annular cup-shaped container 212 has a bottom 217 with an optionally and preferentially upwardly protruding central boss 217a and a side wall 218 extending upward from the bottom to a circular rim 219. The circular lid 215 sits flush against the raised center section of the annular cup-shaped container 212. The central boss 217a provides an additional surface to which heat may be applied to insure fast and even heating of the food contents. As will be appreciated by those skilled in the art, said boss is not a necessary part of the invention and may be eliminated if the added complexity does not provide sufficient benefit to the heating or extrusion process.

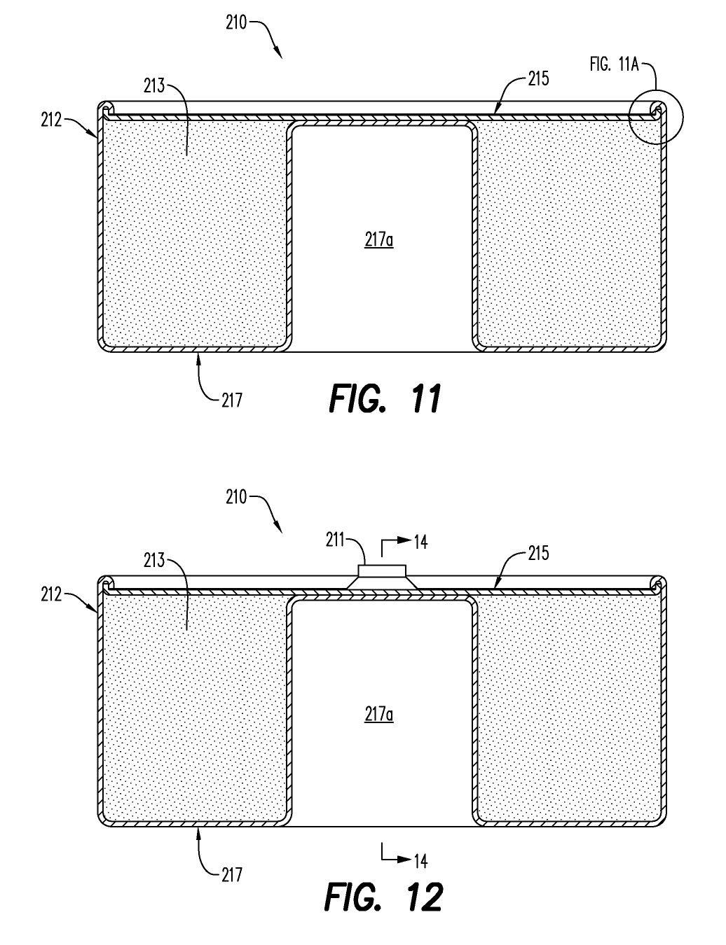

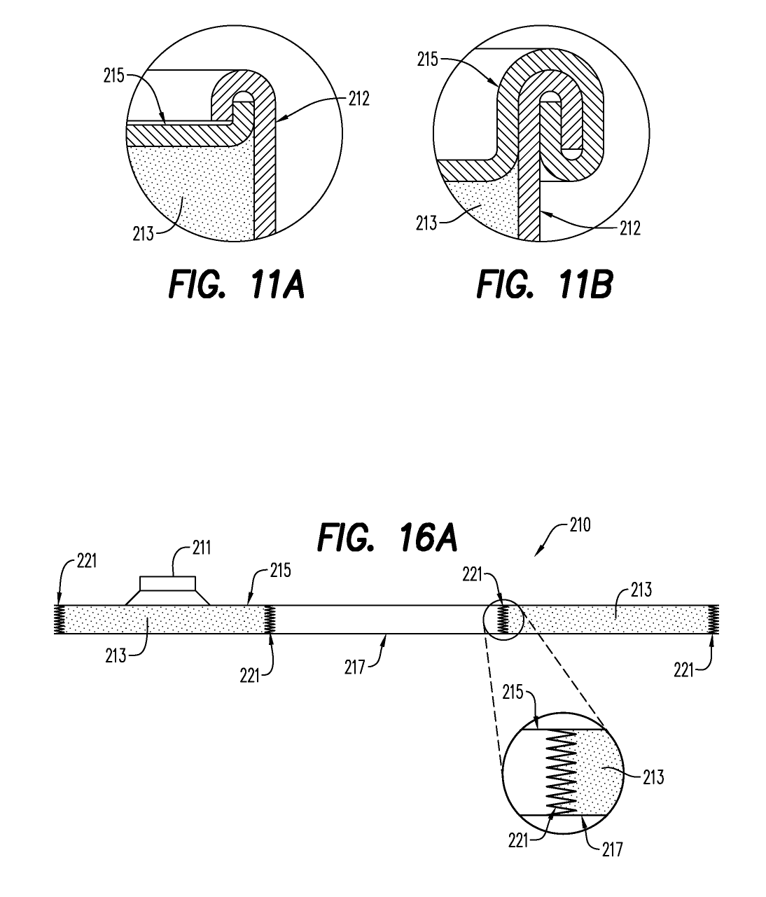

The side wall 218 and the edge of the planar circular lid 215 may be crimped together to form a seal as shown in the detail views of FIGS. 11A and 11B. Other methods of sealing the lid to the cup may be employed including but not limited to welding, gluing, press fitting, or other industry standard method.

The planar circular lid 215 is shown with an integral extrusion die nozzle 211. This nozzle may be formed in one piece with the lid, or it may be formed as a separate piece and attached to the lid using any number of industry standard methods. The nozzle 211 is sealed in order to preserve the freshness of food 213 and also to allow pressure to build during the cook cycle.

Burst disk 216 acts as the seal and is designed to controllably break open when sufficient pressure builds inside the sealed container. The burst disk 216 may be formed in one piece with the lid and/or nozzle, but is shown as a separate piece. If the disk is a separate piece, it may be bonded to the lid using any number of industry standard methods including welding, gluing, crimping, etc. The burst disk 216 may be made of a material that is thin enough to burst under sufficient pressure, or may include features designed to facilitate a controlled bursting, such as shallow grooves cut or otherwise formed in the disk. Under pressure, the burst disk 216 would fail at said grooves.

As shown in FIG. 15, the cross section of the nozzle 211 may be round or it may be another preferable shape only limited by the method of manufacture and requirements of the particular food extrusion. The nozzle shape will cause the food to be formed into the same or substantially similar shape during the dispensing phase of the cooking process. In fact, the burst disk may be designed such that, upon bursting, it forms the nozzle.

Alternatively, the nozzle may be designed to be recessed inside the container and during the cooking process is forced to move outwards due to the pressure inside the container 212. A recessed nozzle may facilitate the stacking of the product inside its shipping and sales packaging.

The annular cup-shaped container 212 is preferably formed from a high temperature tolerant, impermeable, thermally conductive material, comprised of, for example, aluminum. Aluminum has the additional benefits of malleability, light weight, corrosion resistance and can be easily and completely recycled.

As will be understood by those skilled in the art, other materials may be used including but not limited to other metals and plastics. In some cases, for example, it may be advantageous to combine metal and plastic in order to facilitate sealing, fusing, labeling, etc.

At the onset of a processing cycle, the container 212 and circular lid 215 are preferably in close proximity to (i.e., touching and supported by) a heating element (not shown) integral to a cooking chamber. On the bottom side of the cartridge (opposite the nozzle 211) a piston 214 pushes against the bottom 217 of the container 212. The pressure this piston exerts varies throughout the cooking process. As the food 213 is heated and compressed, the sealed container 212 allows pressure to build inside the cartridge. The pressure required to cook the food 213 varies depending upon the type and formulation of the food 213.

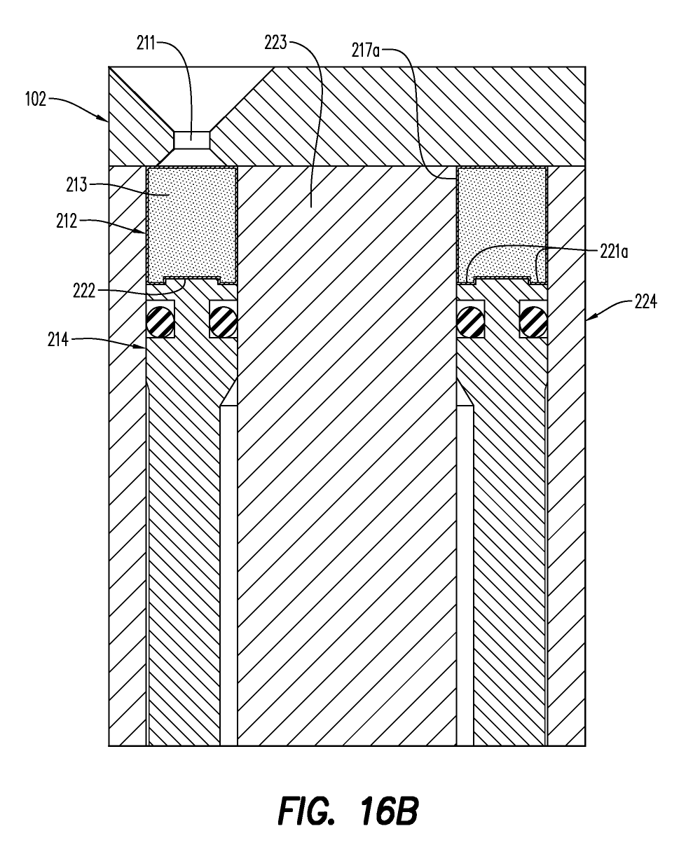

At the appropriate time, or a combination of pressure and temperature set points, or whenever else commanded, the piston 214 is mechanically forced against the container 212 so as to controllably crush it thereby forcing the food 213 to break open the burst disk 216 and exit the nozzle 211. The piston continues to crush the container and extrude the food through the nozzle until the food is completely purged and the container is crushed flat. Due to the pressure inside the container, and the restraining walls of the cooking chamber, the walls of the container are uniformly crushed flat in an accordion-like manner 221 similar to that shown in FIG. 16A.

The resulting flat token-like crushed container is void of sharp edges and is of a size and shape convenient for storage until recycle or disposal. After the container is crushed, the piston 214 may be used to push it out of the cooking chamber. The piston is then retracted prior to the next cooking process.

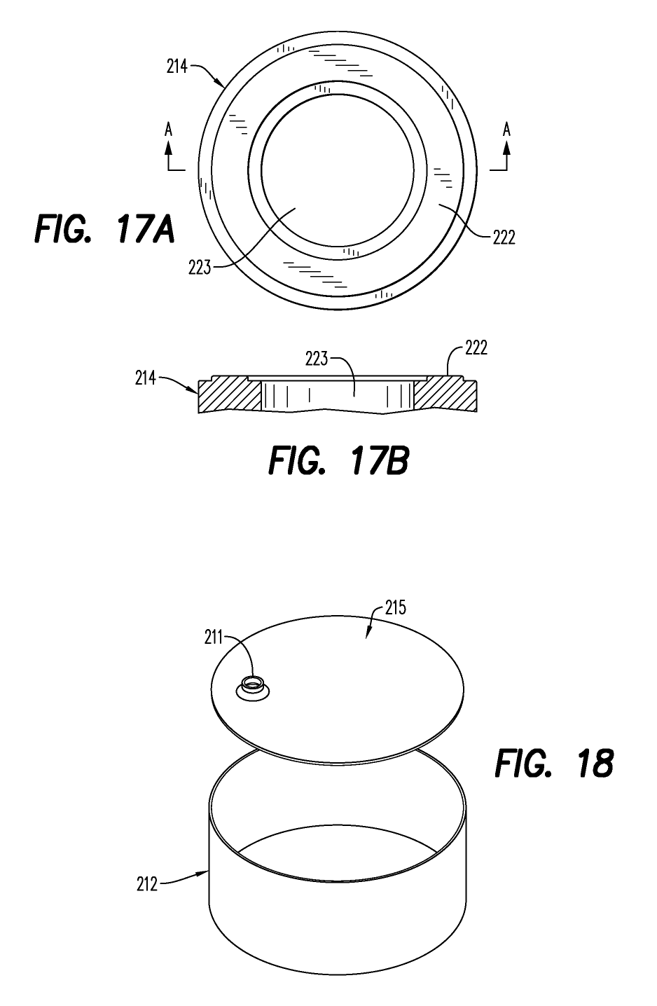

As shown in FIG. 16A, some food may remain in the container after it is completely crushed. An alternate embodiment of the piston shown in FIGS. 17A and 17B contains a raised ring 222 which will further crush the container to insure complete ejection of the food. As shown in FIG. 16B, the center boss 217a in the container surrounds the inner wall 223 of the apparatus when the container is placed in the apparatus. The container is held in place by the outer chamber restraining wall 224. The piston in FIG. 16B acts on the bottom of the container, causing the accordion-like crushed walls 221 to collapse into the pre-formed wells 221a in the bottom of the container. In an alternative embodiment, wells in the container that receive the accordion-like crushed walls are not pre-formed, but rather, created under the application of pressure by the raised ring 222 of the piston 214 to the bottom of the container.

In another embodiment, the center boss 217a may be eliminated as depicted in FIG. 18. While the heating surface area is reduced by the elimination of the boss, additional heating area on the bottom of the container is now available. The overall height of the container is reduced so heat transfer through the bottom of the container to the thinner layer of food above is improved. The smaller container reduces packing, shipping, and storage costs. There is less material to crush as the food is being ejected meaning the piston force can be reduced. Finally, the procedure to manufacture the container is simplified resulting in lower production costs.

In an additional embodiment, the nozzle 211 may be positioned near the center of the top lid 215 as shown in FIG. 19. The final nozzle position depends upon the nozzle size, heating appliance and food characteristics during the extrusion process.

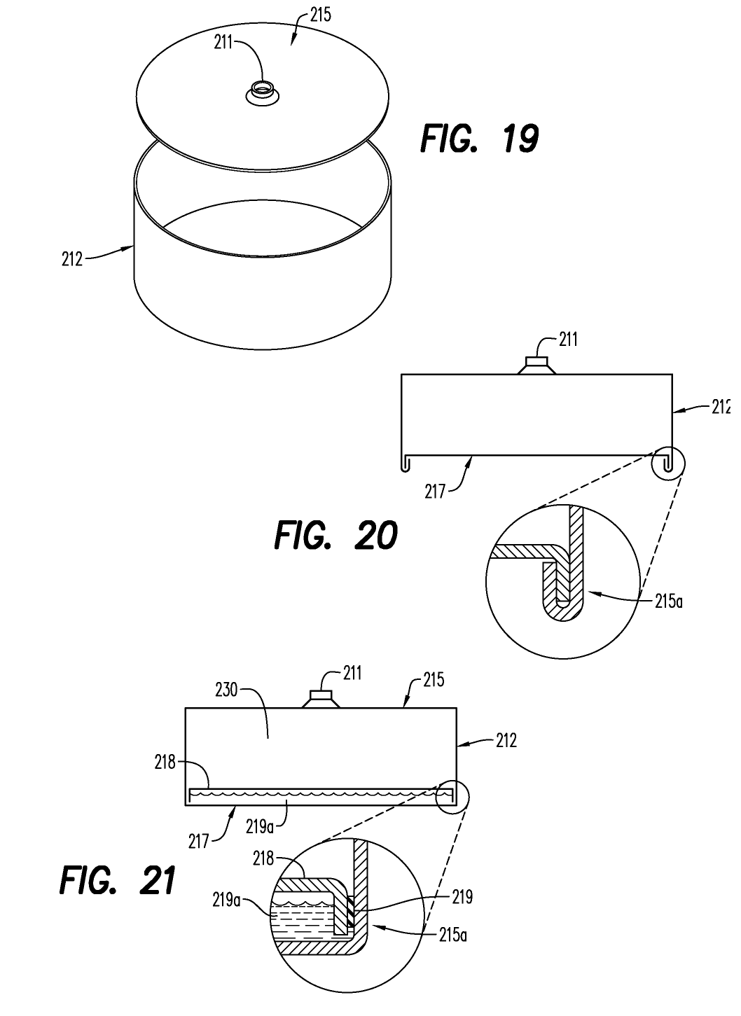

The bottom lid of the food container may be a separate piece crimped to the side wall of the container as illustrated in FIG. 20. In this embodiment, the entire bottom lid 217 is moved toward the top of the container when food is ejected. The sidewalls of the container are not crushed. The crimp 215a is designed to allow the bottom lid to easily break free from the sidewalls.

In a further embodiment illustrated in FIG. 21, the bottom lid 217 and side 212 of the food container may be formed—i.e., deep drawn—from a single piece of metal. An additional formed “piston” disk 218 containing a circumferential seal 219 is inserted into the container sealing between it and the bottom disk 217 a premeasured amount of water 219a or other liquid. Food material is placed in the chamber 230 above the piston disk 218 and the top lid 215 is then attached using the methods previously discussed. As the food product is heated, the water 219a boils and pressure builds between the disks 217 and 218. When the desired pressure is reached, the burst disk ruptures, food is ejected through the nozzle 211, pressure in the cavity between 217 and 218 reduces causing additional boiling of the water 219a and the pressure moves the disk 218 toward the top of the food container.

It is easily appreciated that different food formulations, different serving sizes, and different extrusion dies all may require different cooking times, temperatures, and pressures. The food container may be affixed with one of a plurality of possible “sensory” devices which will indicate to a “reader” installed in the cooking appliance the desired cooking regimen, i.e., each individual pod may have an attached bar code containing process parameters (mix time, pressure, temperature, extrusion velocity, cutter speed, etc.) unique to the intended finished food product. The code is read by the appliance's control system at the beginning of the process, as more fully described herein below.

There are a variety of possible sensory devices that may be used. Possibilities include but are not limited to various barcodes, magnetic strips, conductive or resistive elements, resonant devices, physical features—e.g., bumps or depressions in the container, and RFID chips. It is also apparent that the cost of such features may preclude their use in which case it may fall to the user of the appliance to select a cooking procedure using a keypad or other type of user input device.

The pods shown are all designed and sized as a home appliance for conveniently producing single and/or multiple servings of nutritious, freshly made food products for humans or pets. Food ingredients are purchased separately as a pre-formulated and pre-mixed batch that is hermetically sealed inside a pod of the type shown, constructed of food grade material which has an integrated extrusion nozzle. In pet food application, pods are formulated and sized according to specific daily nutrition requirements of end use animals, which is beneficial to portion control and weight management.

Each batch ingredient has a moisture percentage that is low enough to prevent bacterial growth and rancidity during pod storage. Optionally, the ingredient batch can be:

a) Hermetically sealed within a nitrogen environment (preferred embodiment); or

b) Sterilized through a retort process.

If the finished food product requires fat for nutritional value:

a) Fat is stored in a separate, replaceable appliance reservoir outside of the pod and is spray dispensed onto the finished food product as it exits from the pod nozzle. Flavorings and seasonings can be dispensed in the same manner (preferred embodiment); or

b) A separate pouch containing the required measurement of fat is included inside the pod, with the fat being dispensed into the finished food product as that product exits from the pod nozzle. Flavorings and seasonings can be dispensed in the same manner.

The following is a generic description of the process. Process parameters would be adjusted depending on food ingredients:

1. A food pod is loaded into the appliance's process chamber, the chamber door is closed and the start button is pushed. From that point, the rest of the process is automatically controlled via microprocessor.

2. In the preferred embodiment, the food material is pre-formulated and mixed with required moisture included, but if water is needed, water can be added to the ingredients within the pod by:
a) Mechanically applying pressure to burst the seal of a dedicated channel that connects a water blister within the pod to the main volume of the pod, allowing required water to flow into the dry ingredients;
b) Mechanically piercing the seal of a dedicated channel that connects a water blister within the pod to the main volume of the pod, allowing required water to flow into the dry ingredients; or
c) Pumping required water from a refillable reservoir within the appliance and injecting that water through the pod wall and into the dry ingredients.

3. If water is added, the ingredients within the pod and the water are mixed by:
a) A combination of timed vibration at controlled frequencies and mechanical manipulation of the pod contents; or
b) Heating the pod to the ambient boiling point of its contained water. The water would mix with the dry ingredients via steam migration.

4. The pod is pressurized to a defined process pressure between 50 psi and 400 psi while heated until the food material reaches a defined temperature between 140 C and 150° C. (approximately eight minutes). At that temperature, the pod pressure is increased to a defined extrusion pressure between 300 psi and 500 psi at which the pod nozzle is opened.

5. As the extrusion pressure is maintained, the food material is driven through the pod nozzle in a continuous flow where it expands upon exit and is cut into equal segments.

Once the process is complete, the spent pod is simply removed from the chamber and recycled.

The process can also be started with an integral timer. The user would load a pod into the process chamber and set the desired start time.

Process and extrusion pressures are generated and maintained by decreasing/increasing the closed volume of the process chamber in which the pod is placed. This can be accomplished with:

a) a steam/relief valve combination (preferred embodiment);

b) a piston/lead-screw/reversible motor combination;

c) a piston/lead-screw/reversible motor/non-compressible high temperature fluid combination; or

d) a thermally expandable fluid/relief valve combination.

Process and extrusion pressures are confirmed by:

a) timeout acquired from test data (preferred embodiment); or

b) feedback from a pressure transducer.

Process heat is generated with:

a) steam (preferred embodiment); or

b) electric heater(s).

Process temperatures are confirmed by:

a) timeout acquired from test data (preferred embodiment); or

b) feedback from thermocouples placed at specific locations within the process chamber.

The pod nozzle opens when the thin edge of an integrated burst disk shears due to the force generated from the extrusion pressure being applied to the disk area. A small, thicker segment of the disk edge does not shear and acts as a hinge, keeping the sheared disk attached to the nozzle as the food material exits. The rigid pod nozzle includes specially engineered geometry for optimum expansion and texture of the food product. The discharging/expanding food material is cut by:

a) a series of rotating blades. Segment length is set by adjustment of blade rotation speed, and is monitored via current feedback from the blade motor. (preferred embodiment); or

b) Reciprocating star-burst disk integral to the (rigid) pod nozzle, activated by pulsed extrusion pressure.

Food expansion occurs as a result of flashing (instant boiling) of most of the water content within the food material upon exposure to atmospheric pressure outside of the pod nozzle. Expansion rate and final moisture content are controlled by regulation of the initial moisture and starch percentages of the pre-formulated ingredient batch within the pod.

The invention can be used for producing a variety of freshly made and nutritiously balanced foods including but not limited to:
Breakfast Cereals
Snack Foods
Pet Foods
Pastas
Croutons

Each food type has unique characteristics in palatability, texture and density which result from pressure and temperature being specifically applied to its original moisture and starch contents during a specified cooking time. Moisture and starch contents vary from food type to food type. Thus, required pressure and temperature values vary as well, but are within the ranges shown in the following process methods. The food's flavor is primarily determined by the base ingredients of the food recipe. Each food type can be produced by one or either of two processing methods, described below.

Method 1 (approximately 8 minutes)

1. Food pod is loaded into the process chamber.

Required process parameters are sent to the appliance's on-board controller via bar code on food pod.

2. Start button is pushed.

3. Food pod is pressurized via piston to required cooking pressure (approximately 10 seconds).

Food material is cooked as food pod temperature is ramped via conductive heaters to required extrusion temperature (approximately 8 minutes). Cooking pressure is maintained constant.

4. Once food material attains required extrusion temperature, food pod cooking pressure is elevated to required extrusion pressure (approximately 10 seconds).

5. Extrusion pressure activates opening of food pod nozzle and pressurized food material is extruded through the nozzle as extrusion pressure is maintained constant. Food material expands as it exits the nozzle and is cut into desired segments by a series of rotating blades. Segment length is controlled with blade speed. Segment shape (cross section) is controlled with nozzle geometry.

Process ends when all food material has exited the food pod.

Parameters

(Ranges shown accommodate processing of various food types)

Cooking Pressure Range: 40 psi to 400 psi

Extrusion Temperature Range: 120° C. to 220° C.

Extrusion Pressure Range: 300 psi to 500 psi

Method 2 (approximately 8 minutes)

1. Food pod is loaded into the process chamber.

Required process parameters are sent to the appliance's on-board controller via bar code on food pod.

2. Start button is pushed.

3. Food pod is pressurized via piston to required dwell pressure (approximately 10 seconds).

Food material is partially cooked as food pod temperature is ramped via conductive heaters to a dwell temperature that is slightly below the finished cooking temperature of the food material. Temperature is dwelled for approximately 6 minutes while dwell pressure is maintained constant.

4. Food material is fully cooked as dwell temperature is ramped to required extrusion temperature (approximately 2 minutes).

5. Once food material attains required extrusion temperature, food pod dwell pressure is elevated to required extrusion pressure (approximately 10 seconds).

6. Extrusion pressure activates opening of food pod nozzle and pressurized food material is extruded through the nozzle as extrusion pressure is maintained constant. Food material expands as it exits the nozzle and is cut into desired segments by a series of rotating blades. Segment length is controlled with blade speed. Segment shape (cross section) is controlled with nozzle geometry.

7. Process ends when all food material has exited the food pod.

Parameters

(Ranges Shown Accommodate Processing of Various Food Types)

Dwell Pressure Range: 40 psi to 400 psi

Dwell Temperature Range: 100° C. to 180° C.

Extrusion Temperature Range: 120° C. to 220° C.

Extrusion Pressure Range: 300 psi to 500 psi

Having described certain embodiments of the invention, it will be apparent to those of ordinary skill in the art that other embodiments incorporating the concepts disclosed herein can be used without departing from the spirit and the scope of the invention. Accordingly, the described embodiments are to be considered in all respects only as illustrative and not restrictive.

We claim:

1. A recyclable food pod or cartridge, for use in a low shear food cooker/extruder apparatus, for the customized, on demand, production from pre-formulated food material stored within said cartridge of fresh, ready to eat food and pet food products, with better quality due to minimized starch damage within the final product, at an economical cost per batch, comprising:
a. a container within which such food material is sealed for storage and cooking, having a thin side wall, a top wall and a bottom wall, said side, top and bottom walls being made from recyclable material;
b. an integral burst disk located within said container under said top wall;
c. a discharge die located on said top wall above said burst disk for controlling the expansion rate, cross-sectional shape, and finished texture of the food product; and
d. a sensory device with information for controlling the thermo-mechanical processing of such food material by such apparatus while in said container;
e. wherein said side wall is collapsible when controlled pressure is applied on said bottom wall of said container to permit said container to be crushed in order to assist in the ejection of such processed food material through said burst disk and said discharge die; and
f. wherein said cartridge isolates such food material and such processed food product from such apparatus, thereby simplifying or eliminating cleanup after cooking.

2. The cartridge of claim 1 wherein said burst disk and discharge die are located in the center area of said top wall.

3. The cartridge of claim 1 wherein said burst disk and discharge die are offset from the center area of said top wall.

4. A recyclable food cartridge, for use in a low shear food cooker/extruder apparatus, for the customized, on demand, production from pre-formulated food material stored within said cartridge of fresh, ready to eat food and pet food products, with better quality due to minimized starch damage within the final product, at an economical cost per batch, comprising:
a. an annular cylindrical container within which such food material is sealed for storage and cooking, having a thin inner side wall, a thin outer side wall, a top wall and a bottom wall, said inner side, outer side, top and bottom walls being made from recyclable material;
b. an integral burst disk located within said container under said top wall;
c. a discharge die located on said top wall above said burst disk; and
d. a sensory device with information for controlling the thermo-mechanical processing of such food material by such apparatus while in said container;
e. wherein said inner side wall and said outer side wall are collapsible when controlled pressure is applied on said bottom wall of said container to permit said container to be crushed in order to assist in the ejection of such processed food material through said burst disk and said discharge die; and
f. wherein said cartridge isolates such food material and such processed food product from such apparatus, thereby simplifying or eliminating cleanup after cooking.

5. The cartridge of claim 4 wherein at least one of said top wall and said bottom wall includes an inner annular well and an outer annular well into which said inner side wall and said outer side wall respectively collapse when controlled pressure is applied on said bottom wall of said container to permit said container to be crushed in order to assist in the ejection of such processed food material and to flatten said cartridge into a thin, recyclable disk.

6. The cartridge of claim 4 wherein both of said top wall and said bottom wall include an inner annular well and an outer annular well into which said inner side wall and said outer side wall respectively collapse when controlled pressure is applied on said bottom wall of said container to permit said container to be crushed in order to assist in the ejection of such processed food material and to flatten said cartridge into a thin, recyclable disk.

7. The cartridge of claim 4 wherein at least one of said top wall and said bottom wall is capable of having an inner annular well and an outer annular well formed therein upon the application of pressure thereto, into which said inner side wall and said outer side wall respectively collapse when controlled pressure is applied on said bottom wall of said container to permit said container to be crushed in order to assist in the ejection of such processed food material and to flatten said cartridge into a thin, recyclable disk.

8. The cartridge of claim 4 wherein both of said top wall and said bottom wall are capable of having an inner annular well and an outer annular well formed therein upon the application of pressure thereto, into which said inner side wall and said outer side wall respectively collapse when controlled pressure is applied on said bottom wall of said container to permit said container to be crushed in order to assist in the ejection of such processed food material and to flatten said cartridge into a thin, recyclable disk.

9. The cartridge of claim 4, wherein said cylindrical container has a diameter from about 0.25″ to about 4″ and a length of from about 0.5″ to about 18″.

10. The cartridge of claim 4, wherein a variety of sizes and shapes of dies can be used for said discharge die to produce different finished products and to accommodate different viscosity products.

11. The cartridge of claim 4 further comprising cutting means for cutting such processed food product as it is extruded through said discharge die.

12. The cartridge of claim 4, wherein such food material contains a pre-determined water content, and pressurizing and heating such food material in said container causes such food material to be extruded out said discharge die and to expand as a result of flashing of most of the water content within such food material upon exposure to atmospheric pressure outside of said discharge die to thereby form such processed food product.

13. The cartridge of claim 12, wherein said cartridge further includes means for adding water to such food material before it is extruded.

14. The cartridge of claim 13, wherein said water adding means comprises a water blister chamber within said container, which blister chamber is mechanically burst or pierced, allowing water from said blister chamber to flow into said container and be mixed together with such food material by a combination of timed vibration at controlled frequencies and mechanical manipulation to form such processed food product.

15. The cartridge of claim 13, wherein said cartridge further includes means for adding fat, flavorings or seasonings to such food material as it is extruded for nutritional value or if such processed food product requires flavorings or seasonings.

16. The cartridge of claim 15, wherein said fat adding means comprises a reservoir within said container, and said cartridge further includes means for opening said reservoir to dispense its contents on such processed food product as such processed food product is extruded.

17. A recyclable food cartridge, for use in a low shear food cooker/extruder apparatus, for the customized, on demand, production from pre-formulated food material stored within said cartridge of fresh, ready to eat food and pet food products, with better quality due to minimized starch damage within the final product, at an economical cost per batch, comprising:
a. an annular cylindrical container within which such food material is sealed for storage and cooking, having a thin inner side wall, a thin outer side wall, a top wall and a bottom wall, said inner side, outer side, top and bottom walls being made from recyclable material;
b. an integral burst disk located within said container under said top wall;
c. a discharge die located on said top wall above said burst disk;
d. cutting means for cutting such food material as it is extruded through said discharge die; and
e. a sensory device with information for controlling the thermo-mechanical processing of such food material by such apparatus while in said container;
f. wherein said inner side wall and said outer side wall are collapsible when controlled pressure is applied on said bottom wall of said container to permit said container to be crushed in order to assist in the ejection of such processed food material through said burst disk and said discharge die;
g. wherein at least one of said top wall and said bottom wall includes an inner annular well and an outer annular well into which said inner side wall and said outer side wall respectively collapse when controlled pressure is applied on said bottom wall of said container to assist in the ejection of such processed food material and to flatten said cartridge into a thin, recyclable disk;
h. wherein said cartridge isolates such food material and such processed food product from such apparatus, thereby simplifying or eliminating cleanup after cooking;
i. wherein said cylindrical container has a diameter from about 0.25″ to about 4″ and a length of from about 0.5″ to about 18″;
j. wherein a variety of sizes and shapes of dies can be used for said discharge die to produce different finished food products and to accommodate different viscosity food products; and
k. wherein such food material contains a pre-determined water content, and pressurizing and heating such food material in said container causes such food material to be extruded out said discharge die and to expand as a result of flashing of most of the water content within such food material upon exposure to atmospheric pressure outside of said discharge die.

18. The cartridge of claim 17, wherein said cartridge further includes means for adding water to such food material before it is extruded.

19. The cartridge of claim 18, wherein said water adding means comprises a water blister chamber within said container, which blister chamber is mechanically burst or pierced, allowing water from said blister chamber to flow into said container and be mixed together with such food material by a combination of timed vibration at controlled frequencies and mechanical manipulation to form such processed food product.

20. The cartridge of claim 19, wherein said cartridge further includes means for adding fat, flavorings or seasonings to such food material as it is extruded for nutritional value or if such processed food product requires flavorings or seasonings.

21. The cartridge of claim 20, wherein said fat adding means comprises a reservoir within said container, and said cartridge further includes means for opening said reservoir to dispense its contents on such processed food product as such processed food product is extruded.

22. A recyclable food cartridge, for use in a low shear food cooker/extruder apparatus, for the customized, on demand, production from pre-formulated food material stored within said cartridge of fresh, ready to eat food and pet food products, with better quality due to minimized starch damage within the final product, at an economical cost per batch, comprising:
a. an annular cylindrical container within which such food material is sealed for storage and cooking, having a thin inner side wall, a thin outer side wall, a top wall and a bottom wall, said inner side, outer side, top and bottom walls being made from recyclable material;
b. an integral burst disk located within said container under said top wall;
c. a discharge die located on said top wall above said burst disk
d. cutting means for cutting such food material as it is extruded through said discharge die; and
e. a sensory device with information for controlling the thermo-mechanical processing of such food material by such apparatus while in said container;
f. wherein said inner side wall and said outer side wall are collapsible when controlled pressure is applied on said bottom wall of said container to permit said container to be crushed in order to assist in the ejection of such processed food material through said burst disk and said discharge die;
g. wherein at least one of said top wall and said bottom wall is capable of having an inner annular well and an outer annular well formed therein upon the application of pressure thereto, into which said inner side wall and said outer side wall respectively collapse when controlled pressure is applied on said bottom wall of said container to assist in the ejection of such processed food material and to flatten said cartridge into a thin, recyclable disk;
h. wherein said cartridge isolates such food material and such processed food product from such apparatus, thereby simplifying or eliminating cleanup after cooking;
i. wherein said cylindrical container has a diameter from about 0.25″ to about 4″ and a length of from about 0.5″ to about 18″;
j. wherein a variety of sizes and shapes of dies can be used for said discharge die to produce different finished products and to accommodate different viscosity products; and
k. wherein such food material contains a pre-determined water content, and pressurizing and heating the food material in said container causes such food material to be extruded out said discharge die and to expand as a result of flashing of most of the water content within such food material upon exposure to atmospheric pressure outside of said discharge die.

23. The cartridge of claim 22, wherein said cartridge further includes means for adding water to such food material before it is extruded.

24. The cartridge of claim 23, wherein said water adding means comprises a water blister chamber within said container, which blister chamber is mechanically burst or pierced, allowing water from said blister chamber to flow into said container and be mixed together with such food material by a combination of timed vibration at controlled frequencies and mechanical manipulation to form such processed food product.

25. The cartridge of claim 23, wherein said cartridge further includes means for adding fat, flavorings or seasonings to such food material as it is extruded for nutritional value or if such processed food product requires flavorings or seasonings.

26. The cartridge of claim 25, wherein said fat adding means comprises a reservoir within said container, and said cartridge further includes means for opening said reservoir to dispense its contents on such processed food product as such processed food product is extruded.

27. A recyclable food pod or cartridge, for use in a low shear food cooker/extruder apparatus, for the customized, on demand, production from pre-formulated food material stored within said cartridge of fresh, ready to eat food and pet food products, with better quality due to minimized starch damage within the final product, at an economical cost per batch, comprising:
a. a container within which such food material is sealed for storage and cooking, having a side wall, a top wall and a break-away bottom wall, said side, top and bottom walls being made from recyclable material;
b. an integral burst disk located within said container under said top wall;
c. a discharge die located on said top wall above said burst disk for controlling the expansion rate, cross-sectional shape, and finished texture of the food product; and
d. a sensory device with information for controlling the thermo-mechanical processing of such food material by such apparatus while in said container;
e. wherein said bottom wall is detachably crimped about its periphery to said side wall, in order to permit said bottom wall to become detached from said side wall and to move towards said top wall when controlled pressure is applied on said bottom wall, in order to assist in the ejection of such processed food material through said burst disk and said discharge die; and
f. wherein said cartridge isolates such food material and such processed food product from such apparatus, thereby simplifying or eliminating cleanup after cooking.

28. A recyclable food pod or cartridge, for use in a low shear food cooker/extruder apparatus, for the customized, on demand, production from pre-formulated food material stored within said cartridge of fresh, ready to eat food and pet food products, with better quality due to minimized starch damage within the final product, at an economical cost per batch, comprising:
a. a container having a first chamber within which such food material is sealed for storage and cooking and a second chamber filled with water;
b. internal piston means mounted within said container and between said first and second chambers, including sealing means for separating said first and second chambers;
c. said container having a side wall, a top wall and a bottom wall, said side, top and bottom walls and piston means being made from recyclable material;
d. an integral burst disk located within said container under said top wall;
e. a discharge die located on said top wall above said burst disk for controlling the expansion rate, cross-sectional shape, and finished texture of the food product; and
f. a sensory device with information for controlling the thermo-mechanical processing of such food material by such apparatus while in said container;
g. wherein when heat is applied to such water in said second chamber, pressure builds up within said second chamber, causing said piston means to move towards said top wall in order to assist in the ejection of such processed food material through said burst disk and said discharge die; and
h. wherein said cartridge isolates such food material and such processed food product from such apparatus, thereby simplifying or eliminating cleanup after cooking.

29. A recyclable food pod or cartridge, for use in a low shear food cooker/extruder apparatus, for the customized, on demand, production from pre-formulated food material stored within said cartridge of fresh, ready to eat food and pet food products, with better quality due to minimized starch damage within the final product, at an economical cost per batch, comprising:
a. a container within which such food material is sealed for storage and cooking, having a thin side wall, a top wall and a bottom wall, said side, top and bottom walls being made from recyclable material;
b. an integral burst disk located within said container under said top wall;
c. a discharge die for controlling the expansion rate, cross-sectional shape, and finished texture of the food product, recessed within said container, above said burst disk and under the surface of said top wall; and
d. a sensory device with information for controlling the thermo-mechanical processing of such food material by such apparatus while in said container;
e. wherein said discharge die is forced to move outwards when controlled pressure is applied on said bottom wall of said container;
f. wherein said side wall is collapsible when controlled pressure is applied on said bottom wall of said container to permit said container to be crushed in order to assist in the ejection of such processed food material through said burst disk and said discharge die; and
g. wherein said cartridge isolates such food material and such processed food product from such apparatus, thereby simplifying or eliminating cleanup after cooking

30. A low shear food cooker/extruder apparatus for use with a recyclable food pod or cartridge, for the customized, on demand, production from pre-formulated food material stored within such cartridge of fresh, ready to eat processed food and pet food products, with better quality due to minimized starch damage within such processed food product, at an economical cost per batch, wherein such pod comprises a container within which such food material is sealed for storage and cooking, such container having a top wall, a bottom wall and a side wall made from recyclable material, an integral burst disk located within such container under such top wall, a discharge die located on such top wall above such burst disk for controlling the expansion rate, cross-sectional shape, and finished texture of the processed food product, and a sensory device with information for controlling the thermo-mechanical processing of such food material by said apparatus while in such container, such side wall being collapsible when controlled pressure is applied on such bottom wall to permit such container to be crushed in order to assist in the ejection of such processed food material through such burst disk and such discharge die;
said apparatus comprises a compression module, a drying module and a control unit;
said compression module having a chamber for receiving such pod, having means for applying process parameters of pressure and temperature to such food material in such pod, means for collapsing such pod within said chamber of said compression module; and means for expelling such processed food product from such pod and from said compression module;
said dryer module having means for drying the expelled processed food product; and
said control means having means for controlling operation of said compression module and said dryer module;
wherein such cartridge isolates such food material and such processed food product from said apparatus, thereby simplifying or eliminating apparatus cleanup after cooking

31. The low shear food cooker/extruder apparatus of claim 30, wherein said means for applying pressure to such food material in such pod includes piston means for crushing such pod by collapsing such side wall of such pod.

32. The low shear food cooker/extruder apparatus of claim 31, wherein said piston means includes a rotating mechanism to introduce a minimum amount of shear as may be necessary to aid the cooking of such food material, but not enough to damage the resultant processed food product.

33. The low shear food cooker/extruder apparatus of claim 31, wherein such pod is an annular cylinder and said piston means is an annular piston that acts upon such annular pod cylinder.

34. The low shear food cooker/extruder apparatus of claim 33, wherein such annular pod cylinder includes inner and outer annular side walls and inner and outer annular wells in such bottom wall and said annular piston includes a raised annular ring for engaging such bottom wall between such inner and outer wells, thereby insuring optimal expulsion of processed food product from such pod by causing such inner and outer annular side walls of such pod to collapse into such inner and outer annular wells of such bottom wall.

35. The low shear food cooker/extruder apparatus of claim 33, wherein such pod includes a center boss and said apparatus includes an inner wall, and said inner wall is seatingly engaged by and surrounded by such center boss when such pod is placed in said apparatus.

36. The low shear food cooker/extruder apparatus of claim 35, wherein such annular pod cylinder includes inner and outer annular side walls and said annular piston includes a raised annular ring for engaging such bottom wall and creating under pressure inner and outer wells in such bottom wall, thereby insuring optimal expulsion of processed food product from such pod by causing such inner and outer annular side walls of such pod to collapse into such inner and outer annular wells of such bottom wall.

37. The low shear food cooker/extruder apparatus of claim 30, wherein said means for applying process parameters of pressure and temperature to such food material in such pod comprises a quick-release cover for sealingly closing said chamber and a heating element that supplies heat to such pod when it is inserted into said chamber, wherein said means for collapsing such pod within said chamber comprises piston means for applying pressure to such side wall of such pod for collapsing such side wall, and wherein said means for expelling such processed food product from such pod and from said compression module comprises pressure built up within said chamber.

38. The low shear food cooker/extruder apparatus of claim 36, wherein said chamber is a cylindrical container with a diameter from about 0.25″ to about 4″ and a length of from about 0.5″ to about 18″.

39. A combination of a low shear food cooker/extruder apparatus and a recyclable food pod or cartridge, for the customized, on demand, production from pre-formulated food material stored within said cartridge of fresh, ready to eat processed food and pet food products, with better quality due to minimized starch damage within such processed food product, at an economical cost per batch, wherein:
said apparatus comprises a compression module for receiving said pod, having means for applying process parameters of pressure and temperature to such food material in said pod, means for collapsing said pod within said compression module; and means for expelling such processed food product from said pod and from said compression module; and
said pod comprises:
a. a container within which such food material is sealed for storage and cooking, having a thin side wall, a top wall and a bottom wall, said side, top and bottom walls being made from recyclable material;
b. an integral burst disk located within said container under said top wall;
c. a discharge die located on said top wall above said burst disk for controlling the expansion rate, cross-sectional shape, and finished texture of the food product; and
d. a sensory device with information for controlling the thermo-mechanical processing of such food material by such apparatus while in said container;
e. wherein said side wall is collapsible when controlled pressure is applied on said bottom wall of said container to permit said container to be crushed in order to assist in the ejection of such processed food material through said burst disk and said discharge die; and
f. wherein said cartridge isolates such food material and such processed food product from such apparatus, thereby simplifying or eliminating cleanup after cooking.

40. A combination of a low shear food cooker/extruder apparatus and a recyclable food pod or cartridge, for the customized, on demand, production from pre-formulated food material stored within said cartridge of fresh, ready to eat processed food and pet food products, with better quality due to minimized starch damage within such processed food product, at an economical cost per batch, wherein:
said apparatus comprises a compression module for receiving said pod, having means for applying process parameters of pressure and temperature to such food material in said pod, means for collapsing said pod within said compression module; and means for expelling such processed food product from said pod and from said compression module; and
said pod comprises:
a. an annular cylindrical container within which such food material is sealed for storage and cooking, having a thin inner side wall, a thin outer side wall, a top wall and a bottom wall, said inner side, outer side, top and bottom walls being made from recyclable material;
b. an integral burst disk located within said container under said top wall;
c. a discharge die located on said top wall above said burst disk; and
d. a sensory device with information for controlling the thermo-mechanical processing of such food material by such apparatus while in said container;
e. wherein said inner side wall and said outer side wall are collapsible when controlled pressure is applied on said bottom wall of said container to permit said container to be crushed in order to assist in the ejection of such processed food material through said burst disk and said discharge die; and
f. wherein said cartridge isolates such food material and such processed food product from such apparatus, thereby simplifying or eliminating cleanup after cooking.

41. A combination of a low shear food cooker/extruder apparatus and a recyclable food pod or cartridge, for the customized, on demand, production from pre-formulated food material stored within said cartridge of fresh, ready to eat processed food and pet food products, with better quality due to minimized starch damage within such processed food product, at an economical cost per batch, wherein:
said apparatus comprises a compression module for receiving said pod, having means for applying process parameters of pressure and temperature to such food material in said pod, means for collapsing said pod within said compression module; and means for expelling such processed food product from said pod and from said compression module; and
said pod comprises:
a. an annular cylindrical container within which such food material is sealed for storage and cooking, having a thin inner side wall, a thin outer side wall, a top wall and a bottom wall, said inner side, outer side, top and bottom walls being made from recyclable material;
b. an integral burst disk located within said container under said top wall;
c. a discharge die located on said top wall above said burst disk;
d. cutting means for cutting such food material as it is extruded through said discharge die; and
e. a sensory device with information for controlling the thermo-mechanical processing of such food material by such apparatus while in said container;
f. wherein said inner side wall and said outer side wall are collapsible when controlled pressure is applied on said bottom wall of said container to permit said container to be crushed in order to assist in the ejection of such processed food material through said burst disk and said discharge die;
g. wherein at least one of said top wall and said bottom wall includes an inner annular well and an outer annular well into which said inner side wall and said outer side wall respectively collapse when controlled pressure is applied on said bottom wall of said container to assist in the ejection of such processed food material and to flatten said cartridge into a thin, recyclable disk;
h. wherein said cartridge isolates such food material and such processed food product from such apparatus, thereby simplifying or eliminating cleanup after cooking;
i. wherein said cylindrical container has a diameter from about 0.25″ to about 4″ and a length of from about 0.5″ to about 18″;
j. wherein a variety of sizes and shapes of dies can be used for said discharge die to produce different finished food products and to accommodate different viscosity food products; and
k. wherein such food material contains a pre-determined water content, and pressurizing and heating such food material in said container causes such food material to be extruded out said discharge die and to expand as a result of flashing of most of the water content within such food material upon exposure to atmospheric pressure outside of said discharge die.

42. A combination of a low shear food cooker/extruder apparatus and a recyclable food pod or cartridge, for the customized, on demand, production from pre-formulated food material stored within said cartridge of fresh, ready to eat processed food and pet food products, with better quality due to minimized starch damage within such processed food product, at an economical cost per batch, wherein:
said apparatus comprises a compression module for receiving said pod, having means for applying process parameters of pressure and temperature to such food material in said pod, means for collapsing said pod within said compression module; and means for expelling such processed food product from said pod and from said compression module; and
said pod comprises:
a. an annular cylindrical container within which such food material is sealed for storage and cooking, having a thin inner side wall, a thin outer side wall, a top wall and a bottom wall, said inner side, outer side, top and bottom walls being made from recyclable material;
b. an integral burst disk located within said container under said top wall;
c. a discharge die located on said top wall above said burst disk
d. cutting means for cutting such food material as it is extruded through said discharge die; and
e. a sensory device with information for controlling the thermo-mechanical processing of such food material by such apparatus while in said container;
f. wherein said inner side wall and said outer side wall are collapsible when controlled pressure is applied on said bottom wall of said container to permit said container to be crushed in order to assist in the ejection of such processed food material through said burst disk and said discharge die;
g. wherein at least one of said top wall and said bottom wall is capable of having an inner annular well and an outer annular well formed therein upon the application of pressure thereto, into which said inner side wall and said outer side wall respectively collapse when controlled pressure is applied on said bottom wall of said container to assist in the ejection of such processed food material and to flatten said cartridge into a thin, recyclable disk;
h. wherein said cartridge isolates such food material and such processed food product from such apparatus, thereby simplifying or eliminating cleanup after cooking;
i. wherein said cylindrical container has a diameter from about 0.25″ to about 4″ and a length of from about 0.5″ to about 18″;
j. wherein a variety of sizes and shapes of dies can be used for said discharge die to produce different finished products and to accommodate different viscosity products; and
k. wherein such food material contains a pre-determined water content, and pressurizing and heating the food material in said container causes such food material to be extruded out said discharge die and to expand as a result of flashing of most of the water content within such food material upon exposure to atmospheric pressure outside of said discharge die.

43. A combination of a low shear food cooker/extruder apparatus and a recyclable food pod or cartridge, for the customized, on demand, production from pre-formulated food material stored within said cartridge of fresh, ready to eat processed food and pet food products, with better quality due to minimized starch damage within such processed food product, at an economical cost per batch, wherein:
said apparatus comprises a compression module for receiving said pod, having means for applying process parameters of pressure and temperature to such food material in said pod, means for collapsing said pod within said compression module; and means for expelling such processed food product from said pod and from said compression module; and
said pod comprises:
a. a container within which such food material is sealed for storage and cooking, having a side wall, a top wall and a break-away bottom wall, said side, top and bottom walls being made from recyclable material;
b. an integral burst disk located within said container under said top wall;
c. a discharge die located on said top wall above said burst disk for controlling the expansion rate, cross-sectional shape, and finished texture of the food product; and
d. a sensory device with information for controlling the thermo-mechanical processing of such food material by such apparatus while in said container;
e. wherein said bottom wall is detachably crimped about its periphery to said side wall, in order to permit said bottom wall to become detached from said side wall and to move towards said top wall when controlled pressure is applied on said bottom wall, in order to assist in the ejection of such processed food material through said burst disk and said discharge die; and
f. wherein said cartridge isolates such food material and such processed food product from such apparatus, thereby simplifying or eliminating cleanup after cooking.

44. A combination of a low shear food cooker/extruder apparatus and a recyclable food pod or cartridge, for the customized, on demand, production from pre-formulated food material stored within said cartridge of fresh, ready to eat processed food and pet food products, with better quality due to minimized starch damage within such processed food product, at an economical cost per batch, wherein:
said apparatus comprises a compression module for receiving said pod, having means for applying process parameters of pressure and temperature to such food material in said pod, means for collapsing said pod within said compression module; and means for expelling such processed food product from said pod and from said compression module; and
said pod comprises:
a. a container having a first chamber within which such food material is sealed for storage and cooking and a second chamber filled with water;
b. internal piston means mounted within said container and between said first and second chambers, including sealing means for separating said first and second chambers;
c. said container having a side wall, a top wall and a bottom wall, said side, top and bottom walls and piston means being made from recyclable material;
d. an integral burst disk located within said container under said top wall;
e. a discharge die located on said top wall above said burst disk for controlling the expansion rate, cross-sectional shape, and finished texture of the food product; and
f. a sensory device with information for controlling the thermo-mechanical processing of such food material by such apparatus while in said container;
g. wherein when heat is applied to such water in said second chamber, pressure builds up within said second chamber, causing said piston means to move towards said top wall in order to assist in the ejection of such processed food material through said burst disk and said discharge die; and
h. wherein said cartridge isolates such food material and such processed food product from such apparatus, thereby simplifying or eliminating cleanup after cooking

45. A combination of a low shear food cooker/extruder apparatus and a recyclable food pod or cartridge, for the customized, on demand, production from pre-formulated food material stored within said cartridge of fresh, ready to eat processed food and pet food products, with better quality due to minimized starch damage within such processed food product, at an economical cost per batch, wherein:
said apparatus comprises a compression module for receiving said pod, having means for applying process parameters of pressure and temperature to such food material in said pod, means for collapsing said pod within said compression module; and means for expelling such processed food product from said pod and from said compression module; and
said pod comprises:
a. a container within which such food material is sealed for storage and cooking, having a thin side wall, a top wall and a bottom wall, said side, top and bottom walls being made from recyclable material;
b. an integral burst disk located within said container under said top wall;
c. a discharge die for controlling the expansion rate, cross-sectional shape, and finished texture of the food product, recessed within said container, above said burst disk and under the surface of said top wall; and
d. a sensory device with information for controlling the thermo-mechanical processing of such food material by such apparatus while in said container;
e. wherein said discharge die is forced to move outwards when controlled pressure is applied on said bottom wall of said container;
f. wherein said side wall is collapsible when controlled pressure is applied on said bottom wall of said container to permit said container to be crushed in order to assist in the ejection of such processed food material through said burst disk and said discharge die; and
g. wherein said cartridge isolates such food material and such processed food product from such apparatus, thereby simplifying or eliminating cleanup after cooking.

46. A method of customized, on demand, low shear cooking/extrusion of fresh, ready to eat processed food and pet food products, with better quality due to minimized starch damage within such processed food product, at an economical cost per batch, from pre-formulated food material placed in a recyclable, cylindrical food cartridge which serves as both a storage container for the food material and a processing container for cooking/extruding the processed food product, comprising the steps of;
a. placing such cylindrical food cartridge in a low shear cooking/extrusion apparatus;
b. causing such apparatus to heat and pressurize such cartridge until a burst disk within such cartridge ruptures;
c. causing such apparatus to collapse such cartridge into a thin, recyclable disk by means of application of controlled pressure on the bottom of such container;
d. causing the ejection of the processed food product from such cartridge through a discharge die on the top of the cartridge; and
e. isolating such processed food product from the apparatus to thereby simplify or eliminate apparatus cleanup after cooking/extrusion.

47. The method of customized, on demand, low shear cooking/extrusion of fresh, ready to eat processed food and pet food products of claim 46, wherein such apparatus includes a quick-release cover for sealingly closing such chamber and a heating element for heating the cartridge when inserted in the chamber, and wherein the step of causing such apparatus to heat and pressurize such cartridge until a burst disk within such cartridge ruptures includes the steps of sealingly closing the cartridge within the chamber with the cover and heating the food materials in the cartridge by activating the heating element.

48. The method of customized, on demand, low shear cooking/extrusion of fresh, ready to eat processed food and pet food products of claim 46, wherein the step of causing such apparatus to collapse such cylindrical cartridge into a thin, recyclable disk comprises activating a piston which exerts a controlled pressure on the bottom of such cartridge.

49. The method of customized, on demand, low shear cooking/extrusion of fresh, ready to eat processed food and pet food products of claim 48, further including the step of causing the pressure of the piston on the bottom of such cartridge to collapse the side walls of such container.

50. The method of customized, on demand, low shear cooking/extrusion of fresh, ready to eat processed food and pet food products of claim 49, wherein such cartridge includes inner and outer annular wells in the bottom wall, and further including the step of causing the pressure of the piston on the bottom of such cartridge to collapse the side walls of such container into such wells.

51. The method of customized, on demand, low shear cooking/extrusion of fresh, ready to eat processed food and pet food products of claim 49, wherein such piston includes a raised annular ring, and further including the step of causing the pressure of the raised annular ring of the piston on the bottom of such cartridge to create inner and outer annular wells in the bottom wall of such cartridge and to collapse the side walls of such container into such wells.

52. The method of customized, on demand, low shear cooking/extrusion of fresh, ready to eat processed food and pet food products of claim 48, further including the step of activating a rotating mechanism to introduce a minimum amount of shear as may be necessary to aid the cooking of such food material, but not enough to damage the resultant processed food product.

53. The method of customized, on demand, low shear cooking/extrusion of fresh, ready to eat processed food and pet food products of claim 46, wherein the discharge disc is recessed within the cartridge, and the step of causing the ejection of the processed food product from such cartridge through a discharge die on the top of the cartridge comprises applying pressure to the discharge disc to cause it to move to the top wall.

54. The method of customized, on demand, low shear cooking/extrusion of fresh, ready to eat processed food and pet food products of claim 46, wherein such pod includes a center boss and such apparatus includes an inner wall, further including the step of seatingly engaging such center boss on such inner wall when such pod is placed in said apparatus.

55. The method of customized, on demand, low shear cooking/extrusion of fresh, ready to eat processed food and pet food products of claim 46, further including the step of drying the expelled processed food product.

56. The method of customized, on demand, low shear cooking/extrusion of fresh, ready to eat processed food and pet food products of claim 46, further including the step of applying fat, flavorings or seasonings to the expelled processed food product.

57. A method of customized, on demand, low shear cooking/extrusion of fresh, ready to eat processed food and pet food products, with better quality due to minimized starch damage within such processed food product, at an economical cost per batch, from pre-formulated food material placed in a recyclable, cylindrical food cartridge which serves as both a storage container for the food material and a processing container for cooking/extruding the processed food product, comprising the steps of;
a. placing such cylindrical food cartridge in a low shear cooking/extrusion apparatus;
b. causing such apparatus to heat and pressurize such cartridge until a burst disk within such cartridge ruptures;
c. causing the bottom wall of such cartridge to move towards the top wall of such cartridge by means of application of controlled pressure on the bottom of such cartridge;
d. causing the ejection of the processed food product from such cartridge through a discharge die on the top of the cartridge; and
e. isolating such processed food product from the apparatus to thereby simplify or eliminate apparatus cleanup after cooking/extrusion.

58. The method of customized, on demand, low shear cooking/extrusion of fresh, ready to eat processed food and pet food products of claim 57, wherein such step of causing such bottom wall of such cartridge to move towards the top wall of such cartridge by means of application of controlled pressure on the bottom of such cartridge comprises activating a piston which exerts a controlled pressure on the bottom of such cartridge.

59. The method of customized, on demand, low shear cooking/extrusion of fresh, ready to eat processed food and pet food products of claim 57, further including the step of causing the pressure of the piston on the bottom of such cartridge to detach the bottom wall from the side walls of such container and move the bottom wall towards the top wall.

60. The method of customized, on demand, low shear cooking/extrusion of fresh, ready to eat processed food and pet food products of claim 57, wherein the cartridge includes an internal piston and a chamber filled with water between the piston and the bottom wall, further including the steps of heating the water in the chamber to apply pressure to the piston to move the piston away from the bottom of such cartridge towards the top wall.

61. A method of customized, on demand, low shear cooking/extrusion of fresh, ready to eat processed food and pet food products, with better quality due to minimized starch damage within such processed food product, at an economical cost per batch, from pre-formulated food material placed in a recyclable, cylindrical food cartridge which serves as both a storage container for the food material and a processing container for cooking/extruding the processed food product, comprising the steps of;
a. placing such cylindrical food cartridge in a low shear cooking/extrusion apparatus;
b. seatingly engaging a center boss of the cartridge on an inner wall of the apparatus when such pod is placed in said apparatus;
c. sealingly closing the cartridge within the apparatus by closing a cover of the apparatus;
d. heating the food materials in the cartridge by activating a heating element in the apparatus;
e. causing the apparatus to heat and pressurize the cartridge until a burst disk within the cartridge ruptures;
f. activating a piston in the apparatus which exerts a controlled pressure on the bottom of such cartridge;
g. causing the pressure of the piston on the bottom of such cartridge to collapse the side walls of such container into wells in the bottom wall of the cartridge;
h. causing such apparatus to collapse such cartridge into a thin, recyclable disk;
i. causing the ejection of the processed food product from such cartridge through a discharge die on the top of the cartridge; and
j. isolating such processed food product from the apparatus to thereby simplify or eliminate apparatus cleanup after cooking/extrusion;

62. The method of customized, on demand, low shear cooking/extrusion of fresh, ready to eat processed food and pet food products of claim 61, further including the step of activating a rotating mechanism to introduce a minimum amount of shear as may be necessary to aid the cooking of such food material, but not enough to damage the resultant processed food product.
